(19) United States
(12) Patent Application Publication
(10) Pub. No.: US 2024/0420490 A1
(43) Pub. Date: Dec. 19, 2024

(54) MICROGLIAL CELL MORPHOMETRY

(71) Applicant: Denali Therapeutics Inc., South San Francisco, CA (US)

(72) Inventors: Meredith Calvert, South San Francisco, CA (US); David Joy, South San Francisco, CA (US)

(73) Assignee: Denali Therapeutics Inc., South San Francisco, CA (US)

(21) Appl. No.: 18/701,573

(22) PCT Filed: Oct. 19, 2022
(86) PCT No.: PCT/US2022/047090

§ 371 Date: Apr. 15, 2024

Related U.S. Application Data
(60) Provisional application No. 63/257,514, filed on Oct. 19, 2021.

(51) Int. Cl. G06V 20/69; G06T 7/00; G06V 10/762; G06V 10/774; G06V 10/82

(52) U.S. Cl. CPC G06V 20/698; G06T 7/0014; G06V 10/762; G06V 10/774; G06V 10/82; G06V 20/695; G06T 2200/04; G06T 2207/10056; G06T 2207/10064; G06T 2207/20081; G06T 2207/20084; G06T 2207/30024; G06V 2201/03

(57) ABSTRACT

Methods and systems described herein may allow for the classification of microglial morphology at single cell resolution. Microglial cell states may be determined, and a biological sample from which the microglial cells are obtained may be classified based on the microglial cell states. Classifying microglial cells may involving segmenting microglia cells into soma and processes in immunofluorescence microscopy images. Additionally, a feature bank may be generated. Values of the features in the feature bank may be measured for an image. Cells may be clustered using the values of the features in the feature bank. The cells in a cluster may be compared to a reference cell with a known state and having known morphological properties. The cluster in the cell may then be assigned the same state as a reference cell. The amount of cells having the state may then be used to determine properties of the biological sample.

This application claims priority to U.S. Provisional Application No. 63/257,514, filed Oct. 19, 2021, the disclosure of which is hereby incorporated by reference in its entirety for all purposes.

### BACKGROUND

Microglia are one of the key immune cell types in the central nervous system (CNS), acting to clear damaged or pathological debris, support tissue regeneration, and maintain brain homeostasis. Microglia exhibit a wide variety of morphological phenotypes, which are observed changes in the shape or expression of genes within a microglial cell in response to disease or treatment. Many phenotypes have been associated with immune surveillance, inflammation, and response to chronic neurodegeneration as in Alzheimer's disease. Each phenotype may correspond to one or more internal microglial states that reflect disease-relevant semantic categories, such as “activated” or “quiescent.” However, while hundreds of microglial morphological parameters may be measured, it remains unclear both what parameters are most relevant to measuring the underlying microglial state and how population level heterogeneity in microglial response impacts health and disease. Embodiments described herein address these and other needs.

### BRIEF SUMMARY

We have developed methods and systems described to classify microglial morphology at single cell resolution. Microglial cell states can be determined, and a biological sample from which the microglial cells are obtained can be classified based on the microglial cell states. As examples, such classifications of a biological sample can enable diagnosing disorders or assessing treatment of such disorders in the subjects from which the biological samples were obtained. Such classifications and associated machine learning models can be specific to a particular experiment, e.g., for a diagnostic or a dosage response to a treatment.

Classifying microglial cells may involving segmenting microglia cells into soma and processes in image data, e.g., immunofluorescence microscopy images. The soma and processes can be analyzed to identify features for a machine learning model for use in classifying states of the microglial cells in a sample. The features can be used to identify microglia that are similar to each other (e.g., via a cluster process). Such groups (clusters) of similar microglia can then be analyzed together to determine a state for the entire group. Such state classification at the cluster level is more accurate than classifying individual microglial cells.

As part of identifying a specific set of features for use in clustering the microglia in a sample, a feature bank may be generated. All or some of the features in the feature bank may be identified for use in a clustering model (e.g., based on discriminating power), where such features may vary from experiment to experiment. Values of the features in the feature bank may be measured for one or more images. The cells may be clustered using the values of the features in the feature bank. For example, a matrix of the features for each of the cells can be fed into a clustering model to group the cells into a variable or predetermined number of clusters.

As part of classifying a cluster of microglial cells, representative features of cells in a cluster may be compared to reference values determined from one or more reference cells with a known state and having known morphological properties. A cluster may then be assigned the same state as a matching reference cell, e.g., when a difference in the feature values is less than a threshold. The amount (e.g., a proportion) of cells having a particular state may then be used to determine properties of the biological sample and/or the subject. For example, the biological sample may show a treatment is effective or ineffective.

These and other embodiments of the disclosure are described in detail below. For example, other embodiments are directed to systems, devices, and computer readable media associated with methods described herein.

A better understanding of the nature and advantages of embodiments of the present invention may be gained with reference to the following detailed description and the accompanying drawings.

### BRIEF DESCRIPTION OF THE DRAWINGS

FIG. 1 shows different states of microglial cells according to embodiments of the present invention.

FIG. 2 shows images of different morphologies of microglia associated with different states according to embodiments of the present invention.

FIG. 3 illustrates a pipeline for single-cell microglial morphometry according to embodiments of the present invention.

FIG. 4A shows an image of microglia according to embodiments of the present invention. FIG. 4B shows the same microglia segmented according to embodiments of the present invention.

FIGS. 5A, 5B, and 5C show images of microglia according to embodiments of the present invention.

FIGS. 6, 7, and 8 show features and descriptions for soma, process, and/or cell body according to embodiments of the present invention.

FIG. 9 shows a ranking table for features according to embodiments of the present invention.

FIG. 10 shows a ranking table for features according to embodiments of the present invention.

FIG. 11 shows a graph of the adjusted mutual information versus the number of features removed according to embodiments of the present invention.

FIG. 12 shows the adjusted rand score versus the number of features removed according to embodiments of the present invention.

FIG. 13 shows a graph of principal components according to embodiments of the present invention.

FIG. 14 shows cluster of cells in a projection on UMAP according to embodiments of the present invention.

FIGS. 15A, 15B, and 15C show a comparison of using different number of features to cluster cells according to embodiments of the present invention.

FIG. 16 shows the breakdown of homeostatic and responsive cells for different treatments according to embodiments of the present invention.

FIG. 17 is a flowchart of a process of analyzing a biological sample of nerve cells including microglial cells according to embodiments of the present invention.

FIG. 18 illustrates a measurement system according to embodiments of the present invention.

FIG. 19 shows a block diagram of an example computer system usable with systems and methods according to embodiments of the present invention.

### DETAILED DESCRIPTION

Microglia include a soma section, which includes the nucleus, and processes, which are spindly extensions of the cell. Microglia may be activated when there is a disorder of the CNS (e.g., Alzheimer's disease). Hence, the state of microglia may be useful in diagnosing disorders or assessing treatment of such disorders. An image processing pipeline using machine learning models has been developed to classify microglial morphology at single cell resolution, with applications in understanding the impacts of aging, genetic manipulation, disease models, and treatments on the local CNS environment. Each microglial cell may be segmented into a soma and processes by a machine learning model. Methods and systems described herein can efficiently and accurately characterize microglial cells by first identifying clusters of cells with similar features, where the features are extracted after the segmentation process. In addition, methods and systems described herein can also use the characterized microglial cells to determine the effect of a treatment or a genetic perturbation, e.g., using the proportion of microglial cells with a given state (or proportions for various states) in a given sample.

Clusters of cells may be classified as being a certain state based on representative features of the cells of the cluster being compared with one or more reference cells having known states and known morphological properties. The cluster may be classified as having the same known state when the representative values are similar to the reference values.

Such techniques of image analysis to cluster cells and classify the clusters provide advantages over manual categorization of individual microglial cells using image data. Such manual categorization of individual microglial cells is less efficient and may vary based on the skill and experience of the person doing the manual categorization, thereby being less accurate.

Embodiments can advantageously segment the microglial cells into soma and processes from which the features used for clustering and potentially classification may be extracted. Further, embodiments can mine the segmented images to identify a sufficient number of features for accurate categorization of microglial cells. The segmentation model may be implemented using machine learning techniques, e.g., a convolutional neural network. Such a segmentation model has advantages; other segmentation techniques may require manual adjustments, which are time consuming, subjective, and/or error-prone.

The classification of clusters of cells may then be used to determine properties of the biological sample and/or the subject from which the biological sample is obtained. Increases or decrease in the amount (e.g., proportion) of a particular state may indicate that the biological sample is become more or less diseased or that a treatment is more or less effective. In some embodiments, the amounts of cells of particular states can be used to diagnose a disorder.

### I. Microglial Cell Morphology

Microglial cells are immune cells that are part of the immune defense in the central nervous system (CNS). Microglia rapidly alter their activity and morphology in response to pathogens and injury in the brain. The cells may be important in the body's response to a disorder of the CNS (e.g., Alzheimer's disease). A microglial cell is made up of a soma, which contains the nucleus, and processes, which are spindly extensions of the cell. The processes may change their shape in response to injury or disease. The shape of the soma may also change in response to injury or disease. In response to injury or disease, microglia may rapidly change their morphology, spacing, and expression of inflammatory marker genes.

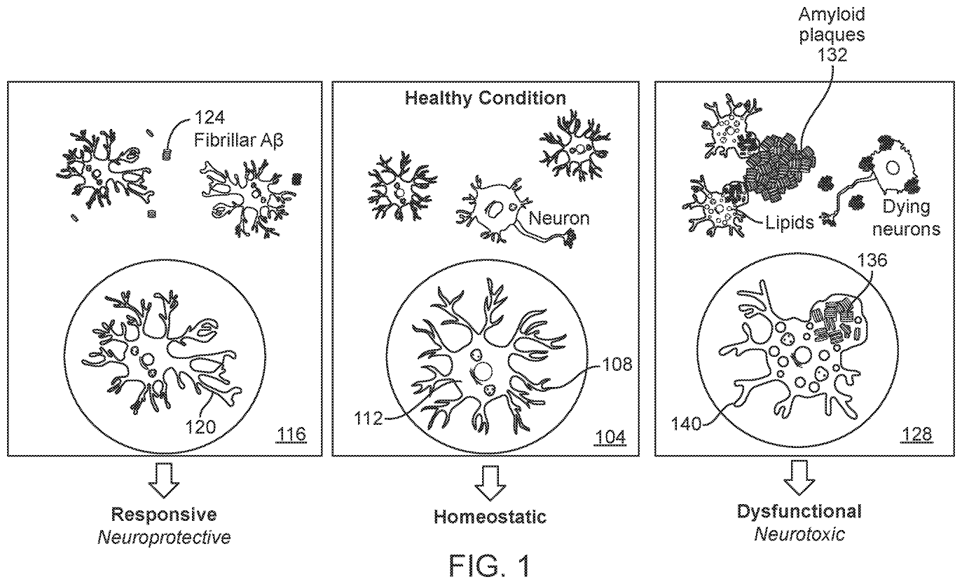

FIG. 1 shows three different states of microglial cells: homeostatic, responsive (neuroprotective), and dysfunctional (neurotoxic). Additional states of microglial cells are possible and not depicted in FIG. 1. The middle portion 104 shows the homeostatic state, which may indicate a healthy condition. The processes (e.g., process 108) surrounding the soma 112 appear to be thin and generally equally distributed around soma 112. Microglia in the homeostatic state may be characterized by having a small cell body, being highly ramified (e.g., having many processes), and having extended processes (e.g., long processes or more branching in processes).

The left portion 116 shows responsive microglia, which performs neuroprotective functions in the CNS. Some processes (e.g., process 120) extend out farther from the soma than other processes. Each non self-intersecting structure coming off of the soma may be considered a single process. The processes extending out may also be thicker and wider at the base than other processes. The processes may extend out to provide protective functions against foreign or harmful bodies (e.g., fibrillar AB 124). Microglia have been shown to be responsive in the vicinity of plaque and other bodies. Responsive microglia may be characterized by having a large cell body, being polarized (e.g., asymmetric distribution of processes around the soma), and having shorter processes.

The right portion 128 shows dysfunctional microglia, which may indicate a neurotoxic situation in the CNS. The microglial cells may attempt to engulf amyloid plaques 132. Engulfing and compacting plaques may be beneficial to the subject having the plaques. Microglia may be able to clear a certain level of amyloid plaque and beyond that level, microglia may cease to be able to clear the plaque, resulting in accumulation of plaques. Alternatively, microglia may cease to function and allow plaque to accumulate. The amyloid plaque (e.g., plaque 136) may enter the microglial cells, resulting in no healthy and thin processes in the microglial cells. The processes (e.g., process 140) may be thicker with less branching out than other states. The dysfunctional microglia may be unable to clear plaque. FIG. 1 shows that different states of microglial cells may appear visually different.

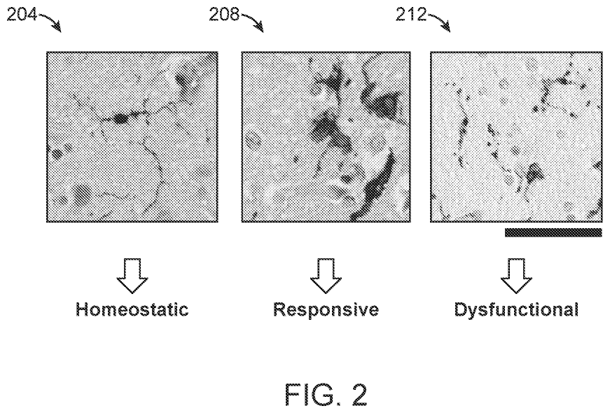

FIG. 2 shows images of different morphologies of microglia associated with different states from Shahidehpour et al., Neurobio. of Aging (2021). FIG. 2 shows the same states of microglia as FIG. 1. Image 204 shows homeostatic microglia. Image 208 shows responsive microglia. Image 212 shows dysfunctional microglia. States other than these shown in FIGS. 1 and 2 are possible for microglia.

Microglia may have different possible configurations depending on the particular disease stage. Methods described herein can assess which states are present or absent, in which proportions, and whether certain pathological or beneficial states are present in a particular animal. Further, by leveraging known markers of a particular state (e.g., morphological measures of polarization), methods may enable discovery of novel biomarkers (e.g., a novel gene target).

For Alzheimer's Disease (AD), methods can assess both how microglia affects AD and how AD affects microglia. Microglia may be key to clearing AD-associated amyloid beta plaques, and they adopt characteristic morphology during plaque clearance. However, as AD progresses, it is currently hypothesized that microglia become exhausted by increasing plaque burden and chronic inflammation. These microglia may become ineffective at clearance and potentially damaging to the surrounding brain tissue. This method can be used to assess to what extent this transition from functional to dysfunctional microglia has occurred, as well as to what extent a given treatment is able to counteract this effect.

### II. Microglial Cell Morphometry Pipeline

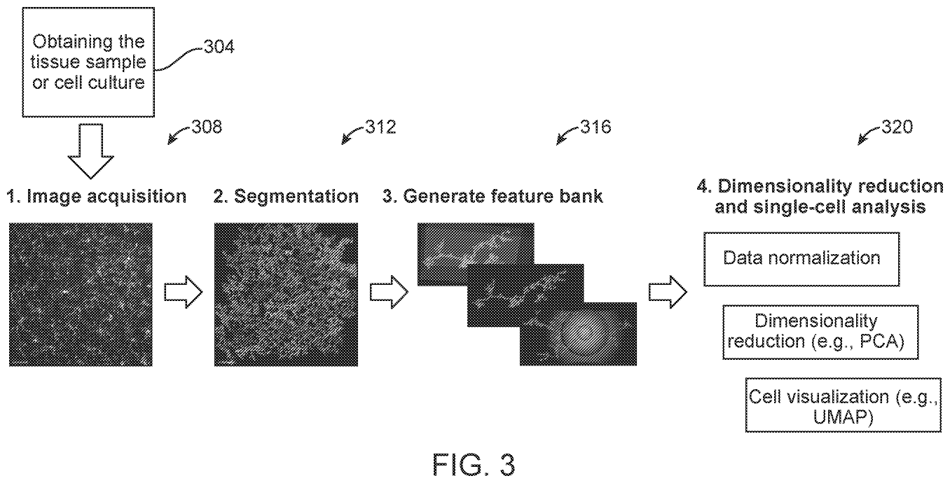

FIG. 3 illustrates a pipeline for microglial morphometry according to embodiments of the present disclosure. The pipeline shows the stages in analyzing images of microglial cells to cluster cells into different microglial states. The distribution of cells in different microglial states may help with diagnosing a subject or determining characteristics of the subject from whom the cells are obtained.

At stage 304, a biological sample (e.g., a tissue sample or cell culture) may be obtained. The tissue sample may be a brain tissue sample or a spinal cord tissue sample.

A biopsy may be performed on a subject, which may be a human or another animal, to obtain a tissue sample. The tissue sample may be a brain tissue sample or a spinal cord tissue sample. A tissue sample may be surgically removed from the subject. In some embodiments, the tissue sample may remain in the subject.

Tissue samples may be obtained post-mortem. Post-mortem brain tissue may be fixed intact and then stained for a marker of the microglia cell body. In some embodiments, a counterstain for processes may be applied. In some embodiments, post-mortem brain tissue may be chemically treated to render the tissue translucent.

Tissue samples may be obtained as part of an experiment to assess a treatment, treatment duration, or genetic perturbation. A first tissue sample may be obtained before a treatment. A treatment may be administered to a subject. The subject may be a human or a non-human, such as a non-human mammal. A second tissue sample may be obtained after the treatment. Another tissue sample may be obtained after a longer duration following the treatment. Experiments may include different animals dosed with different levels of a drug, or animals dosed with the same drug at different times, or animals dosed with different drugs.

In some embodiments, microglial cells may be treated ex vivo and in vitro. In other embodiments, multiple sequential biopsies may be taken from the same animal to show the effect of treatment.

The cell culture may be obtained from a subject. The cell culture may include pluripotent stem cell-derived microglia or iMG (induced microglia-like cells). Cells may be cultured in a high throughput plate format, including, for example, a 96-well or 384-well plate. These cells can then be subjected to a higher number of simultaneous perturbations than in animal models (i.e., treatment, genetic modification) because each well is independent.

At stage 308, images of the tissue sample or cell culture are acquired. Images may be acquired using super resolution scanning confocal microscopy. Images may be acquired through using immunohistochemistry microscopy, confocal microscopy, light sheet microscopy, or other suitable imaging technique. Immunohistochemistry involves using antibodies to target antigens (proteins) in cells. Antibodies may include a stain for microscopy visualization. Immunohistochemistry microscopy includes immunofluorescence microscopy. Immunofluorescence uses antibodies to deliver fluorophores to specific targets. The fluorescence of the fluorophores can be detected by microscopy, thereby confirming the presence of the specific target.

Relevant regions of each section of tissue (e.g., near amyloid plaques) may be imaged to assess the morphology of microglia in that region. Image data may include multiple images from an experiment. An experiment may include two to three images per brain (or tissue) region, one to three brain regions (e.g., cortex, hippocampus) per animal (e.g., human), two to eight animals per treatment or genetic perturbation, and two to five treatment arms or genetic perturbations. As a result, an experiment may include between eight and 360 total images. Each image may include 10 to 20 microglia. Hence, the total number of microglia to be analyzed may be between 80 and 7,200.

In some embodiments, an experiment may include collecting overlapping images sufficient to cover the entire brain (or tissue) region or collecting overlapping volumetric images sufficient to cover all regions in the entire brain (or tissue). These tiled confocal approaches may generate from 500 to 2,500 microglia per tissue region per animal. Light sheet microscopy can image an entire brain. As a result, an image may have 100,000 or more microglia per tissue per region.

High content imaging may include a total of 10,000 to 100,000 microglia, e.g., 20,000, 50,000, or 75,000. High content imaging may image cells in a cell culture. Wells may be imaged using a confocal microscope such that all or a significant portion of each well is covered by the images. High content imaging may result in a large number of images with cells to be analyzed.

At stage 312, the images may be segmented. Portions of the image that correspond to microglia are identified. Portions of the microglia that correspond to soma and processes are identified. Machine learning models may aid in segmenting the microglial cells into somas and processes. Machine learning models may be trained using training images where the soma and processes are identified in the image by an expert having knowledge of microglial cells, a pathologist, or a medical practitioner. Models may determine the location of microglial processes and assign them to individual microglia and also determine the location of the soma for each microglia. Additional detail regarding image data segmentation is discussed herein.

At stage 316, a feature bank may then be generated. Features may include multiple three-dimensional or two-dimensional morphometric measures. The features may be associated with the cell body, soma, or processes. The values of these features may help identify states of the microglia, as shown with FIGS. 1 and 2. Some features may be used by experts to determine certain states of the microglia, but states of the microglia may be associated with other features as well. Values of these features may be measured. Certain values of features that may be associated with states of the microglia cannot be determined by a person viewing an image. For example, calculations involving volume and surface area and statistical measures thereof may be impractical to determine by hand given the geometry of the microglia. Each cell may be characterized by a multidimensional point. The multidimensional point may list the values for each feature of the feature bank. Certain features may be considered important or not important for differentiating different microglial states. The feature bank can be reduced to include only certain features and/or exclude other features. Feature bank generation is discussed in more detail throughout this disclosure.

At stage 320, the dimensionality of the feature bank values may be reduced, and cells may be clustered based on the values. The data may be normalized. For example, features may be transformed from their original distribution into a normalized distribution using a quantile transform. The dimensionality may be reduced and cells clustered using a technique, such as principal component analysis (PCA). The cluster may be determined to have a certain state based on a comparison of feature values with reference values of a reference cell. The reference cell may be a cell previously identified as being a certain state. A cluster having similar feature values as the reference values may be determined to be the same state as the reference cell. All the cells of the cluster may be considered to have the state of the cluster. Clustering is discussed in detail in other portions of this disclosure.

The amount of cells in the cluster may then be used to characterize the biological sample from which the cells are obtained. An increase in the amount of cells of a certain cluster and therefore of a certain state may indicate a treatment is effective or ineffective, a genetic perturbation is harmful or not harmful, or a disease/disorder is present or not present.

The combination of large numbers of cells and highly diverse metrics produced a microglia classification pipeline capable of discriminating fine-grained changes in morphology in response to drug treatment and genetic perturbation.

### III. Image Data Segmentation

Analysis of microglia may involve assessing characteristics of soma and processes. For example, determining a state of microglia as responsive may involve determining that the soma is larger than normal, that the processes are shorter than normal, and that the processes are asymmetric around the soma (i.e., microglia is polarized). As a result, segmenting the microglia into soma and processes can be beneficial.

Machine learning models may be used to segment microglial cells into somas and processes and also to segment microglia from other cells. Models can probabilistically predict not only the location of microglial processes and assign them to individual microglia but also to determine the location of the soma for each microglia.

### A. Generation of Training Samples

To train the segmentation model, training samples can be obtained from an expert. A training sample image can have pixels labeled as being part of a soma or a process. An expert may manually label regions of the image corresponding to somas and regions of the image corresponding to processes. Such labeling can be performed in various ways. For example, the expert can trace an electronic pen over an electronic screen to define a region, and then the expert can select whether the region is a soma or a process. The user interface can also allow the expert to associate a soma and a process as belonging to a same cell. The labeling can be stored as a 100% probability (or 1) for the identified segment (e.g., a soma) and a 0% probability for a process.

A pixel or voxel in the image may be associated with a soma or a process. A voxel is a 3D pixel. Herein, a pixel may be in 2D or 3D. Some pixels or voxels may be unassociated to any object, and thus not be part of any soma or process, and thus not be associated with any microglia. In some implementations, an expert may individually indicate the label for each voxel or pixel to identify which object (segment) the pixel is associated. Such labels can also have probabilities, e.g., in transition regions.

In some embodiments, pixels or voxels between or near the edges of the somas and processes may be labeled differently, e.g., as transition regions. Such pixels can have probabilities that are not 0 or 1. The transition from 0 to 1 (or vice versa) can be specified as a function, e.g., a linear function that transitions over a specified number of pixels.

### B. Output of the Model

The segmentation model can receive an image of the biological sample or a set of images (also referred to as tiles and described in more detail below). For each pixel, the segmentation model can output one or more probabilities of the pixel corresponding to one or more objects in the image (e.g., a part of a cell body, a soma, a process, or to a particular microglia). In one example, a given pixel can have a first probability of being a part of a cell body and a second probability of being a soma. These two probabilities can be for a particular cell. The probability of a process can be determined from the probability being part of the cell body but not the soma. Other pairs of cell body probability and soma probability can be for other cells. Thus, the output for a given pixel can have 2N probabilities, where N is the number of microglia that have been identified.

The set of output probabilities may also specify the probability that the pixel is not within a microglial cell. As mentioned above, a probability may indicate a probability of belonging to a certain microglial cell in the image. This probability can simply be an assignment to a given cell, which can act as a 100% probability for a particular cell. For pixels assigned to cells, a second probability may be outputted to predict that the pixel corresponds to the soma. The processes may then be determined based on a probability of a pixel being assigned to a cell But not assigned to the soma. Alternatively, the second probability may be the prediction of the pixel corresponding to the processes, and the soma may be determined based on the probability of a pixel being assigned to the cell but not assigned to the processes. Thus, the output can be an assignment to a given cell, and an assignment to the soma (100% soma) of that cell or an assignment to the process (100% process) of that cell, or any probabilities in between. For probabilities between 0% and 100%, the probability may be compared to a threshold (e.g., 50%, 60%, 70%, 80%, 90%, 95%) and if the probability is greater than the threshold, the voxel is considered assigned to the particular cell body or portion of the cell.

In some embodiments, the probabilities for a given pixel is determined by the local neighborhood of pixel values around the given pixel. In such implementations, a kernel function can operate on a window of pixels centered around the given pixel. As an example, a convolutional neural network (CNN) can be used. The CNN model may include one or more convolutional layers (e.g., 2D or 3D) with convolution kernels. As an example, a 32×32×32 volume of voxels can be used as an input to the kernels in one or more CNN layers to determine the output in the voxel in the center of the volume.

For example, a model similar to a model used for segmenting neurons from background may be modified to segment microglia (K. Lee et al., IEEE Transactions on Medical Imaging, July 2021 (DOI: 10.1109/TMI.2021.3097826)). The model may be modified to include a second probability output that predicts the location of the microglia soma versus background for each voxel. The block structure (e.g., arrangement of convolutional layers within a block and the non-linearities) and the residual U-net structure network may be the same as in the Lee model.

In some embodiments, the model may segment processes for one cell into individual processes. Such segmentation into individual processes may be used for certain types of analysis (e.g., Sholl analysis). Segmenting processes into individual processes may be performed by determining that pixels associated with processes are separated by a certain threshold distance.

Cells may be separated into individual cells by agglomerative clustering. Agglomerative clustering is a particular clustering algorithm that builds up clusters by hierarchically merging samples based on the closeness of their features, generating a dendrogram which can then be thresholded at a particular height to produce a clustering (scikit-learn.org/stable/modules/generated/sklearn.cluster.AgglomerativeClustering.html). The pipeline can work with any clustering algorithm that accepts as input a sparse affinity or distance matrix (as opposed to raw feature vectors), such as affinity propagation or any other sparse clustering approach. The number of cells can be determined after separating cells into individual cells.

In some embodiments, the output of the segmentation may include segmentation of other objects (e.g., lipid droplets, lysosomes, engulfed amyloids, mitochondria, signal from fluorescently conjugated drug molecules, or signal from surface makers of microglia activation like CD68). These other objects may be segmented using threshold-based segmentation, where an intensity resulting from a stain above a certain threshold indicates the specific object associated with the stain. In some embodiments, the output of segmentation may include determining a morphological skeleton of the microglia.

### C. Training of Model

The model is trained using the training sample images. The parameters of the model (e.g., multiplication weights, coefficients or thresholds for activation functions, etc.) can be determined based on an optimization process to predict the probabilities (e.g., assignments) that match the expected values in the training samples. The optimization can operate to reduce the value of a loss function.

The loss function may represent a difference from the predicted output to the ground truth segmentation of soma or process. The loss function can be a sum of the differences in the probabilities, or some other aggregate function of the differences. The loss function may be reduced or minimized using various optimization techniques.

Techniques may include backpropagation, gradient descent, stochastic gradient descent, empirical risk minimization, structural risk minimization, or other suitable techniques.

### D. Use of Tiling

Further, the network implementation may be programmed to operate in a tiled mode, enabling segmentation of image volumes of arbitrary extent. Each tile, representing a portion of a single image, may be input into the machine learning model. Each tile can be segmented separately. The tile may be one tile of a set of overlapping tiles, with each one being input into the model. A microglial cell (including soma and processes of the cell) may be identified in a first tile and may also occur in a second tile. Thus, in order to de-duplicate, it can be determined that one cell in a tile corresponds to a cell in another tile.

Tiling may be applied to an image larger than the input field of view. Specifically, when segmenting an image larger than the field of view, overlapping probability and embedding masks can be calculated. In some implementations, 50% overlap is the default mode. Probability masks (e.g., the cell body mask and the soma mask) may be merged, e.g., by simple averaging. The cell membership mask can be merged by calculating a sparse affinity matrix between all shared voxels within a field of view, and then performing agglomerative clustering on the resulting affinity matrix.

To match a cell in one tile to a cell in another tile, embodiments can compare non-morphological features of the two cells to determine a match. These non-morphological features may be an unbiased embedding learned by the neural network from training data, without any access to morphology information (e.g., they are calculated at the voxel level). For each voxel, as one of the outputs, the neural network generates a low-dimensional vector (typically 6-8 dimensions) that attempts to embed that voxel in a feature space subject to the following constraints/loss: (1) If two voxels are part of the same cell, they are close in this embedding space; (2) The centroids of voxel clusters belonging to two different cells are far apart in embedding space; (3) The magnitude of the embedding vector for any given voxel is not too large. Matching cells is accomplished by calculating a voxel-wise affinity matrix across all voxels shared between tiles, then performing agglomerative clustering on the resulting affinity matrix. In one aspect, the voxels of a same cluster will correspond to a same cell.

The embedding vector of a voxel may be represented by a multidimensional point having the values for the non-morphological features. The voxel in the overlapping tile may be determined to match or not match a cell in the first tile by comparing the multidimensional points (e.g., clustering) in each tile, or at least the overlapping portion between two tiles. If the values of the multidimensional points are within a certain threshold (e.g., 1%, 2%, 5%, 10%, 15%, or 20%) of each other, then the voxels may be determined to correspond to the same cell. Voxels determined to correspond to the same cell can be labeled with the same identifier (e.g., cell number 1).

Other techniques to segment the microglia may be inefficient and subjective. In some cases, manual techniques require a separate stain for each part of the microglia to be segmented. Because a machine learning model can segment a microglial cell into soma and processes using features that are independent of stain color, a separate stain for soma and a separate stain for processes may no longer be needed. One stain may be used for the entire microglia. For example, typical procedure may use a stain as a microglia marker and then a DAPI (4′,6-diamidino-2-phenylindole) counterstain for the soma. With segmentation by the machine learning model, the DAPI stain may not be needed. Instead, a single stain, such as 1ba1, TMEM119, or other markers can be used so that microglia can be detected. An endogenous label such as a microglia expressing GFP could also be used. Avoiding stains to differentiate between soma and processes frees up stains and/or color channels for other uses (e.g., markers for different states). Techniques described herein therefore improve segmentation by reducing cost and time associated with the stains. In some embodiments, separate stains may still be used and may increase the accuracy of segmentation.

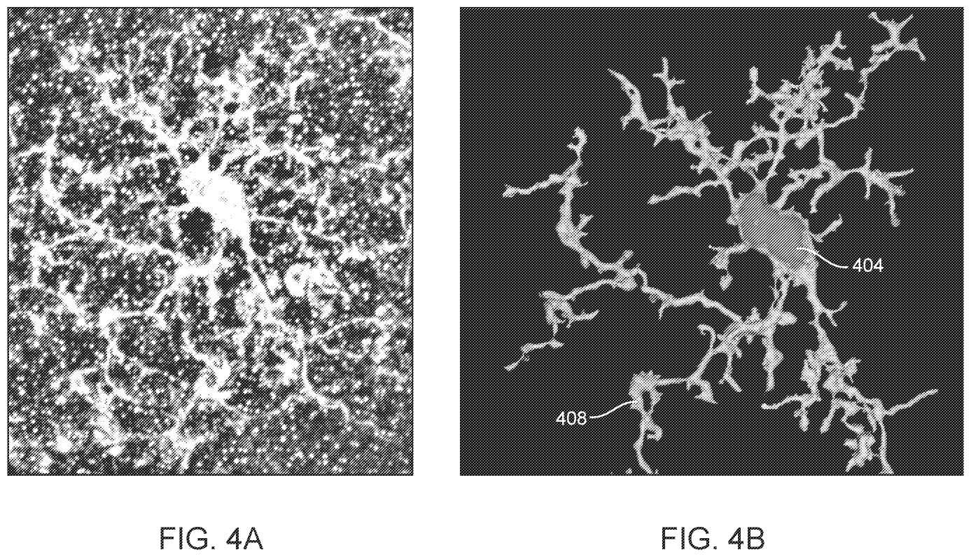

FIG. 4A shows a maximum intensity projection image of microglia stained with 1ba1. FIG. 4B shows the same microglia segmented according to embodiments described herein. The soma is shown in cyan (region 404). The processes are shown in gray (e.g., region 408). FIGS. 4A and 4B show that methods described herein can successfully and accurately segment microglia into soma and processes.

### IV. Feature Bank Generation

Various features may be used to determine the state of a microglial cell. Automated analysis of microglial cells may use these features and determine new features to best understand microglial cells. A bank of features was generated for each microglial surface (i.e., object) based on morphometrics reported in literature as well as additional features not previously reported.

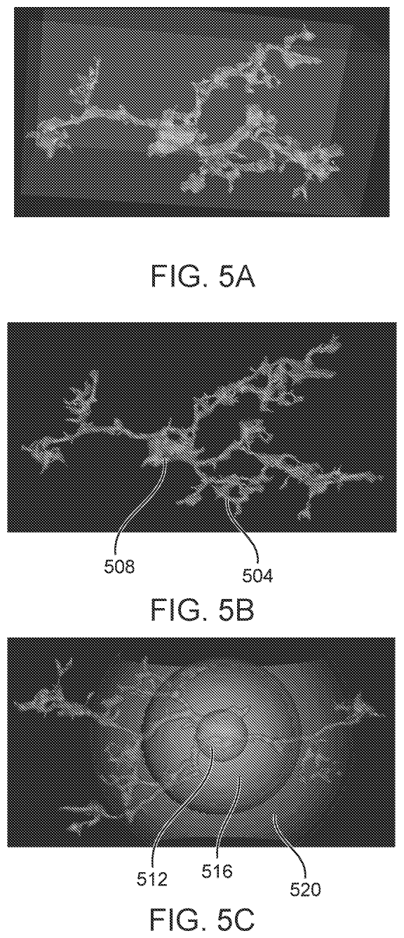

FIG. 5A shows an image of a microglial cell. The cell is one color in order to emphasize that certain features relate to the entire microglia. Features may include volumetric measures, including volume (number of voxels multiplied by voxel pitch), signal intensity, and surface area. Additionally, features may include normalized metrics, such as aspect ratio, circularity (e.g., 4π×area)/(cell perimeter)², sphericity (x\hat{ }(⅓)×(6*volume)\hat{ }(⅔))/(surface area), convexity (surface area)/(surface area of the convex hull), solidity ((volume)/(volume of the convex hull)) and interior/exterior ratio. The interior is calculated by performing a binary erosion of the microglia cell mask corresponding to 1 μm or other values. Then, the exterior is calculated as (cell mask and not interior). Finally, the ratios are calculated as (exterior volume)/(volume) and (interior volume)/(volume). Unitless or other combinations of these measures may be used as features. Other features may include the intensities and variation of fluorescent counterstains within, at, or near each cell surface.

FIG. 5B shows another image of a microglial cell, with two colors to highlight analysis of the processes. The blue (e.g., area 504) shows the morphological skeleton, including lines representing the centers of processes, which are used for analysis of certain features. The gray (e.g., area 508) shows the microglia segmentation of the image. Features may include graph/tree measures, such as the number of branches, the number of branch points, branch length/depth, shortest/longest paths (e.g., in the skeleton from the center of the soma, or from one end of the microglia skeleton to the other), and balanced/unbalanced branch distribution. These parameters may be considered skeletal parameters.

To determine these parameters, the morphological skeleton of the microglia may be calculated. The morphological skeleton may be a skeleton or medial axis representing a shape or binary image, computed using morphological operators. Then, graphical analysis is performed on the skeleton to assign the voxels to classes. Voxels with only 1 or 2 neighbors are tips of branches. Voxels with 3 neighbors are part of a branch. Voxels with greater than 4 neighbors are branch points. Removing all branch points then segmenting all remaining connected components gives the number of branches and statistics about branch length.

FIG. 5C shows an image of a microglial cell, with different spheres to illustrate distances from the soma (indicated by yellow sphere 512). Sphere 516 shows an intermediate distance away from the soma. Sphere 520 shows a farther distance from the soma. Features may include distance measures, including inertia (e.g., moment of inertia), branch thickness/thinness, distance to soma, Sholl analysis, and distance to other surfaces. Fractal parameters such as Sholl coefficients and the box-counting dimension may be features. Sholl analysis may be performed as described in Leyh et al., Cell. Neurosc. 2021 (www.frontiersin.org/articles/10.3389/fncel.2021.701673/full). For Sholl analysis, the radius of maximum branching (the critical radius) and the number of branches at that radius may be calculated. The Schoenen ramification index may be calculated. A branching index may be calculated. Scholl's coefficient from the semi-log method and the corresponding R2 value may also be calculated.

Other features may include the numbers of other segmented objects (e.g., lipid droplets, lysosomes, engulfed amyloids, mitochondria, signal from fluorescently conjugated drug molecules, or signal from surface makers of microglia activation like CD68) contained within the microglial surface and the Boolean combinations of their volumes, the distances between microglia and to other segmented objects, and network parameters calculated from the induced graph of microglial nearest neighbors at different neighborhood sizes. Measurements that may be typically calculated for two-dimensional data may be modified to apply to datasets of two or more dimensions. Features that characterize the microglia in the image itself may be termed primary features. Distances to other surfaces (objects) may depend on experiment. This may include spacing between microglia, distance to nearest plaque, distance to nearest neuron, or distance to nearest blood vessel.

Features may include secondary features that characterize data of primary features rather than being a direct measurement of the microglia. Features may characterize other features that directly measure the microglia. For example, an R² value of a linear regression of fractal dimensions may be a secondary feature, while the fractal dimensions are a primary feature. With microglia, a linear regression may describe the percentage of pixels that correspond to a particular microglial cell for a given zoom level. A fractal dimension may describe the linear regression to fit the percentage to the zoom level. This fractal dimension may indicate how branched a process is. The fractal dimension reflects how self-similar the microglia is at different scales. Ramified microglia develop extremely fine processes that have a fractal-like structure (a trunk splits into coarse processes that split into fine processes, etc.). In contrast, hypertrophic microglia have very little fine structure in their processes (e.g., a thick trunk with a few short branches), so fractal measures help to compare between different kinds of branching. The R² or a coefficient of variation may be a secondary feature that characterizes the linear regression.

For the purposes of certain features (e.g., Sholl analysis), each process may be considered separately. For other features (e.g., number of branch points, branch segment length), features may be calculated for processes of the whole cell rather than for each process of the cell.

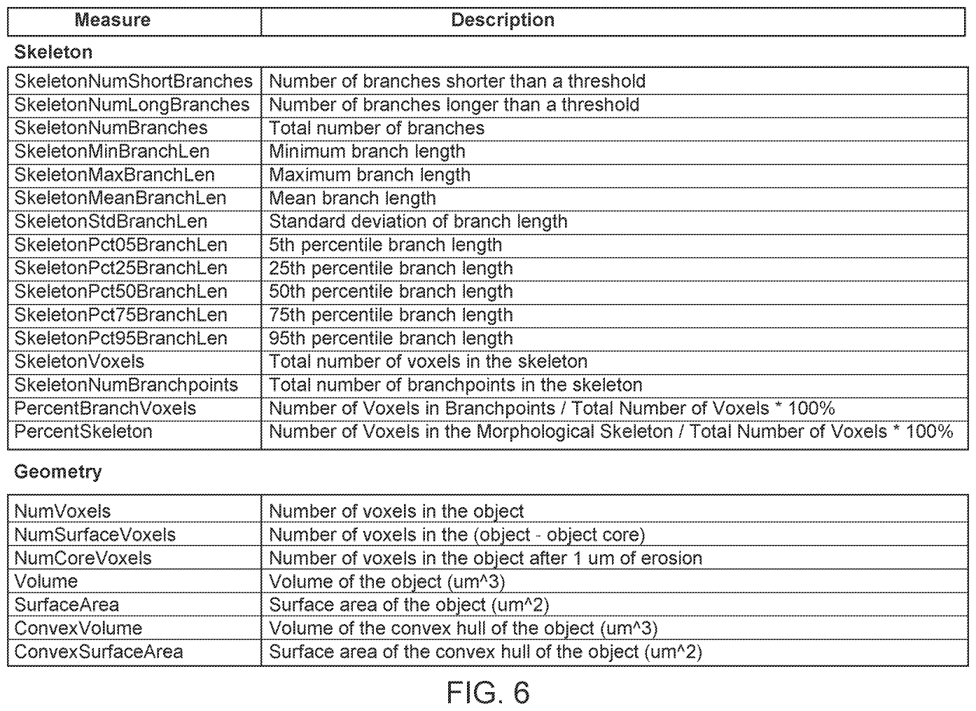

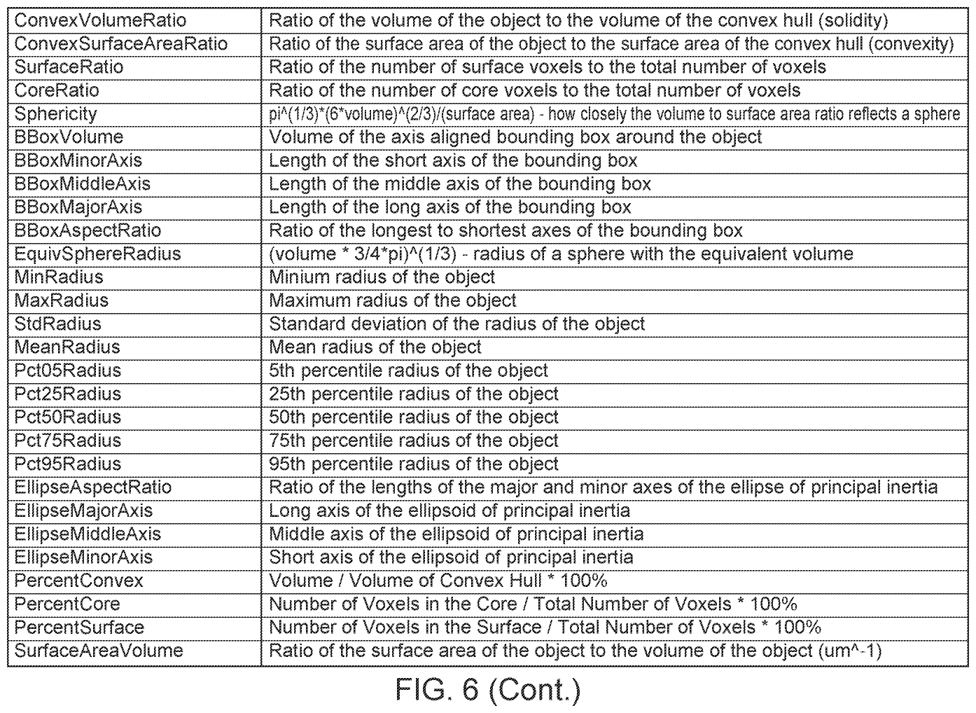

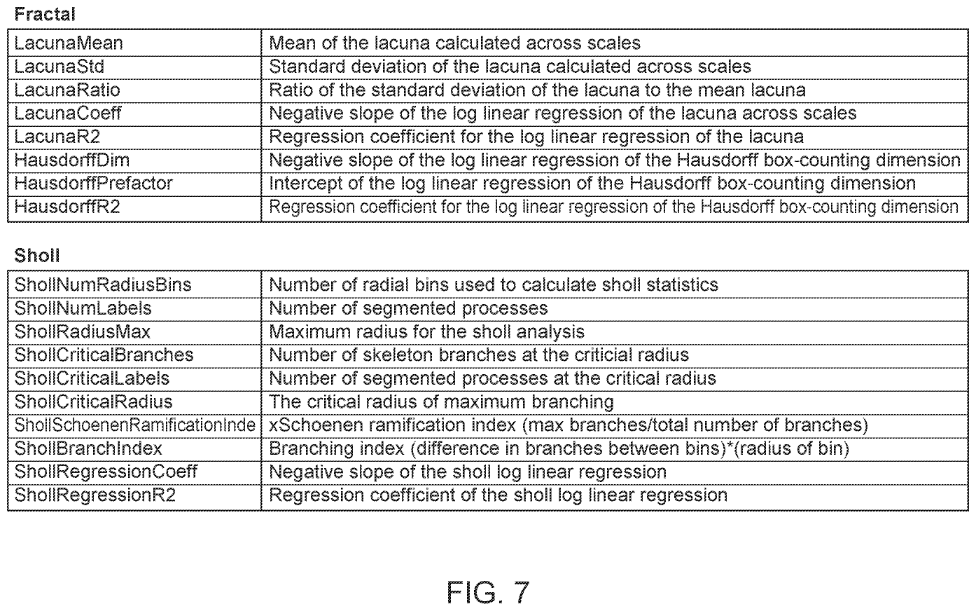

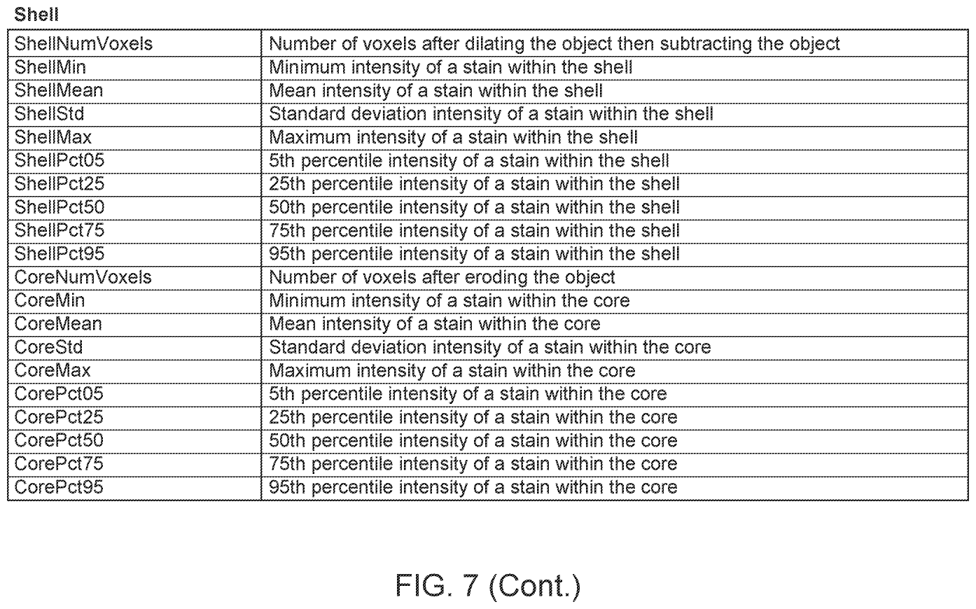

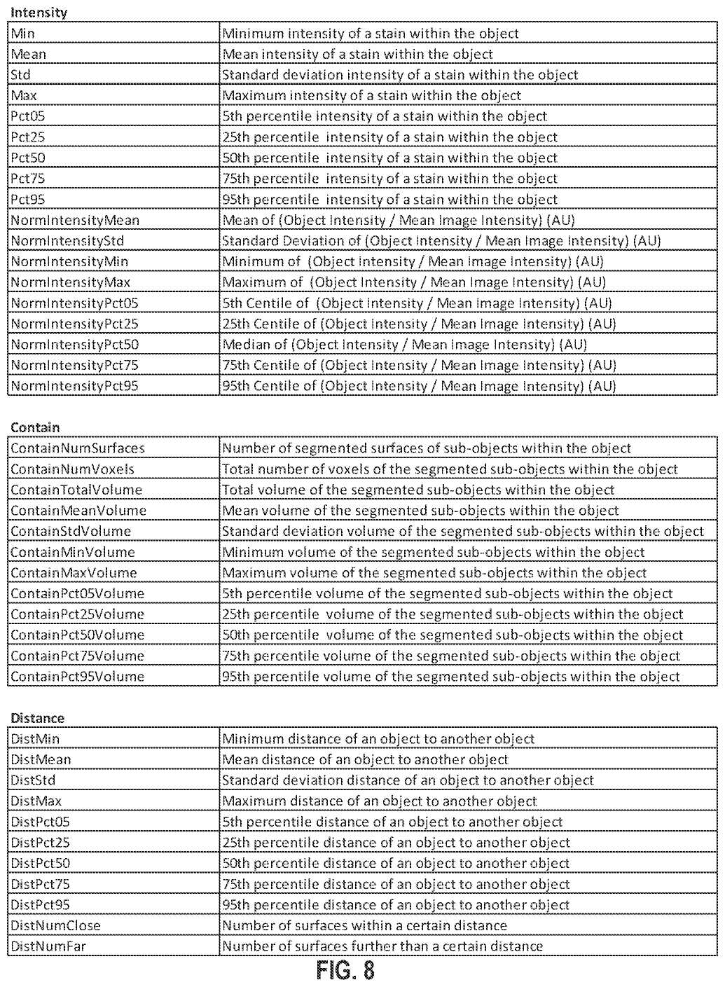

FIGS. 6, 7, and 8 show other possible features. Methods described herein may include any feature listed in the figures, any parameters calculated using the features, as well as any combination of features thereof. “Skeleton” features include features characterizing the number or length of branches. “Geometry” features characterize the size (e.g., voxels, surface area, volume, lengths) of the cell. “Fractal” features indicate how geometric properties of microglia vary with varying length scales (e.g., ratios of branching complexity as branches are examined from largest to smallest). “Sholl” features include morphological characteristics of the microglia, determined from Sholl analysis. “Shell” features include intensity and sizes of shell or core of microglial cells. Both shell and core features may be derived from the morphological segmentation. Core refers to the region of the segmentation that survives isotropic morphological erosion by a distance (e.g., 1 μm). The core mainly reflects the soma of the microglia and potentially very thick processes near the soma. Shell refers to the Boolean subtraction of the segmentation minus the core. The shell may represent the outer 1 μm surface of the microglia, which primarily includes thin processes and the surface of the soma. “Intensity” features characterize the intensity of immunofluorescent stains within microglial cells in soma and/or processes. “Contain” features characterize the number or size of segmented objects (e.g., subcellular compartments such as liposomes, mitochondria, lysosomes and/or proteins, lipids, or other metabolic products) in a cell. “Distance” features describe the distance between cells, soma, or processes or describe the number of objects in a given distance range.

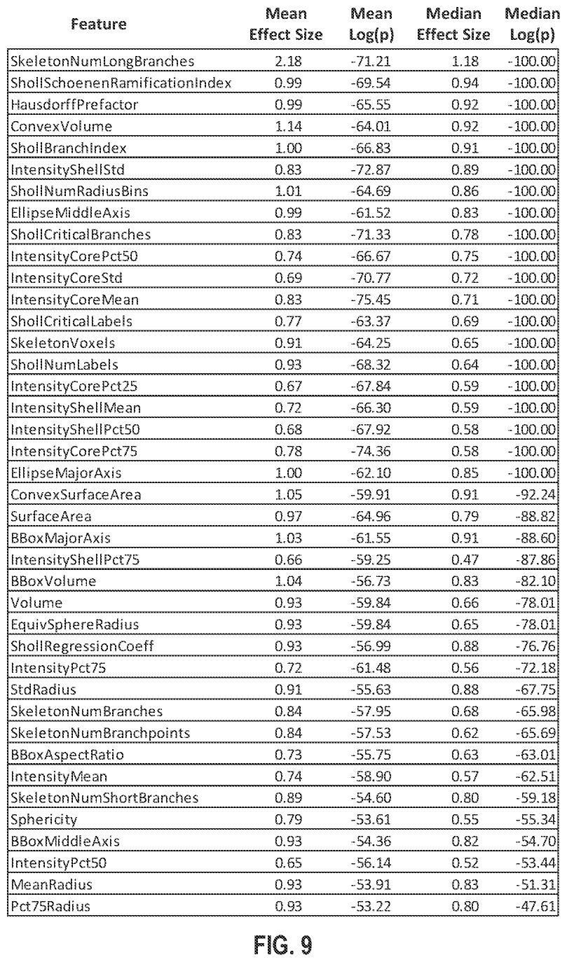

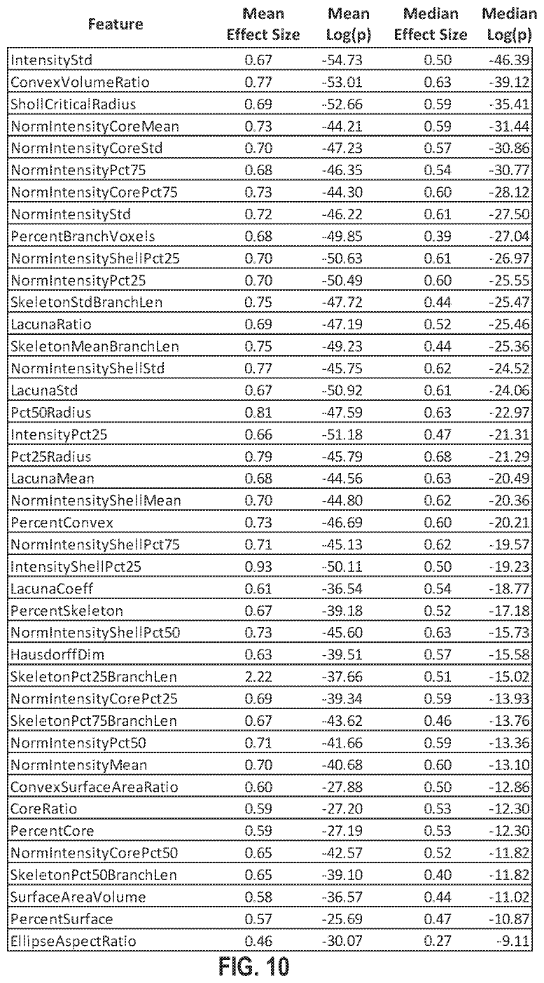

FIGS. 9 and 10 show a ranking table for features. The 82 features listed consistently ranked as significant (p<0.01) across 10 studies including over 14,000 cells. The features are listed in the first columns of FIGS. 9 and 10. The remaining columns characterize the importance of the feature. The second column shows the mean effect size across the 10 studies comparing matched clusters of cells in each study. The effect size is a value measuring the strength of the difference between two populations by comparing the difference of the mean values of a feature to the size of the pooled standard deviation of that feature. The third column shows the mean log (p) value, where p is the p-value. The fourth column lists the median effect size. The fifth column lists the median log (p) value. The features are listed in order of median log (p). Median log (p) was observed to be the best at detecting features important to clustering. Descriptions of the features are listed in FIGS. 6, 7, and 8. FIGS. 9 and 10 include one or more coefficients of regression (e.g., Lacuna R², Hausdorff R², Sholl Regression R²), which are often not used by experts in analyzing images.

An ablation study was performed on a merged dataset to determine the impact of removing features. The merged dataset was of five studies with four clusters corresponding to amoeboid, activated, polarized, and homeostatic microglial states, which were assigned by an expert. The merged set included 5,197 cells. The expert-labeled clusters were used as the ground truth. Features were dropped when simulating 100 studies to see the effect on the accuracy of clustering. Features were dropped in three different manners: (1) uniformly at random (as a baseline); (2) with probability proportional to −log (p) (more significant features more likely to be dropped); or (3) with probability proportional to effect size (larger effect size more likely to be dropped). Simulations included dropping 0 to 30 features.

FIG. 11 shows the adjusted mutual information versus the number of features removed. The x-axis shows the number of features removed. The y-axis shows the adjusted mutual information. The dotted line shows removing features uniformly at random. The solid line shows removing features based on the median effect size. The dashed line shows removing features based on median-log (p) value. The error bars show 95% confidence intervals.

The more than 5,000 cells were first clustered using the entire feature bank, which forms the ground truth. Next, features were ablated (either at random, or proportional to the log (p) or effect size). Then a new clustering was performed. The adjusted mutual information between the two clusterings was then calculated.

If the clusterings were identical (MI=1.0), then removing the feature had no impact on the identification of the cell state. If the clusterings were entirely disjoint (MI=0.0), then the feature was the only important feature to assign cell state. Values of MI between 0.0 and 1.0 indicate the relative importance of the feature to assigning cell state. The fact that MI declines with random ablation shows that all features contribute somewhat to the classification. The fact that MI declines faster when features are ablated proportional to log (p) shows that features with large log (p) values contribute more on average to cell state assignment.

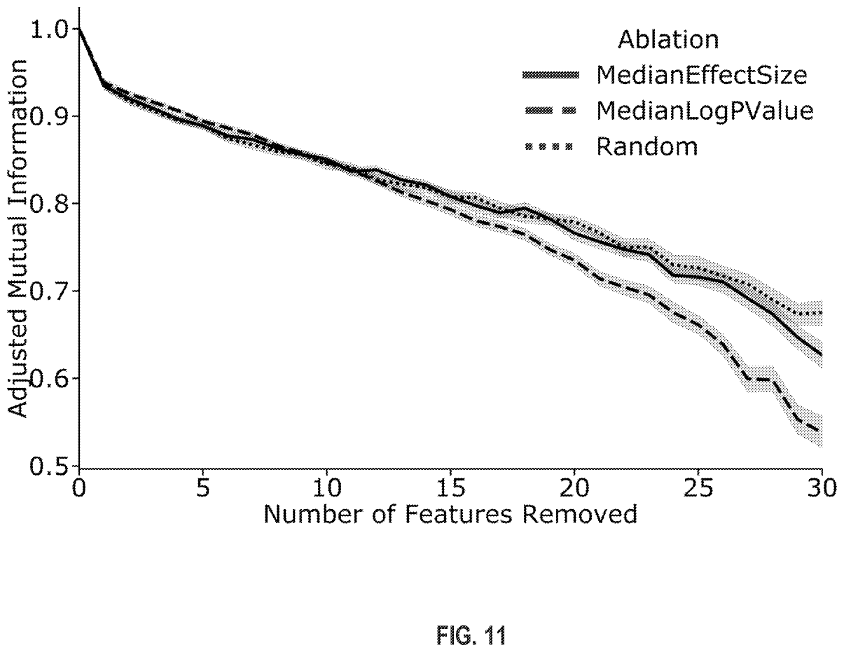

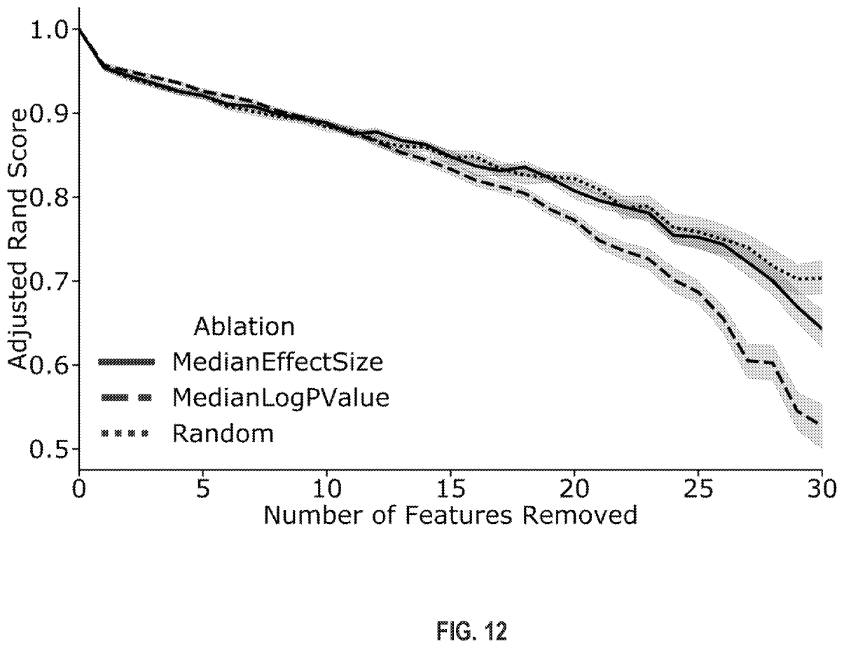

FIG. 12 shows the adjusted rand score versus the number of features removed. The x-axis shows the number of features removed. The y-axis shows the adjusted rand score. The dotted line shows removing features uniformly at random. The solid line shows removing features based on the median effect size. The dashed line shows removing features based on median-log (p) value. The error bars show 95% confidence intervals.

Adjusted rand score is an alternative method for measuring how well two clusters correspond to each other, similar to mutual information. It uses permutation testing instead of information theory to calculate how well clusters correspond (e.g., scikit-learn.org/stable/modules/generated/sklearn.metrics.adjusted_rand_score.html). Adjusted rand score was calculated using the same approach as described above for adjusted mutual information.

In both FIGS. 11 and 12, the line with the steepest drop is the one representing removing features based on median-log (p) value. The line with the next steepest drop is the line representing removing features based on median effect size. Removing features based on median effect size shows overlap with the baseline of removing features at random until close to 30 features removed. FIGS. 11 and 12 show that the top 11 features can be used to reproduce a clustering as good as the entire feature set. Before ablating 11 features, the clustering for random ablations and the clustering for log (p) weighted ablation follow similar trajectories. After 11 features, log (p) weighted ablation declines faster, suggesting that log (p) weighted features are more critical to the clustering than random features. Because all trajectories continue to decline, random features are still important even out to 30 features, but log (p) weighted features are more critical after the top 11 features are removed. FIGS. 11 and 12 also show that the clustering scores degrade out to 30 features, which means that even features that do not have the highest effect or significance aid in clustering.

As shown in FIG. 11, the features with the largest magnitude log (p) include the number of branches longer than a threshold, Schoenen ramification index (max branches/total number of branches), intercept of the log linear regression of the Hausdorff box-counting dimension, volume of the convex hull of the object, branching index (difference in branches between bins*radius of bin), standard deviation intensity of a stain within the shell, number of radial bins used to calculate Sholl statistics, 50^{th} percentile intensity of a stain within the object, standard deviation intensity of a stain within the object, mean intensity of a stain within the object, number of segmented processes at the critical radius, total number of voxels in the skeleton, number of segmented processes, 25^{th} percentile intensity of a stain within the core, mean intensity of a stain within the shell, 50^{th} percentile intensity of a stain within the shell, 75^{th} percentile intensity of a stain within the core, long axis of the ellipsoid of principal inertia, and surface area of the convex hull of the object.

The threshold for branches may be determined empirically by looking at polarized mircroglia (which have very long branches) and ameboid microglia (which have very short branches) and looking for thresholds that separated the two classes of cells from other microglia. For example, short branches may be shorter than 5 μm. Long branches may be longer than 20 μm. The Schoenen ramification index is from the Sholl analysis of a particular cell. Sholl analysis calculates the number of branches crossing a series of spheres of expanding radii. The radius of maximum branching is called the critical radius. This coefficient is (number of branches at the critical radius)/(total number of branches in the cell). The convex hull may be defined as the smallest convex polytope that contains the entire microglial object (en.wikipedia.org/wiki/Convex_hull). If a microglia had no branches (i.e., it was ameboid), the convex hull would be the same as the microglia segmentation. For branched microglia, the convex hull wraps the outermost tips of each process. The ratio of the microglia volume to the convex hull volume is called convexity (2D) or solidity (3D) and may be used to classify microglia. The branching index is from Sholl analysis of a single cell. For each Sholl sphere of a given radius, the number of branches that cross the sphere is calculated. The difference in number of branches between the current sphere and the sphere with the radius the next size up is calculated. The difference in branches is multiplied by the radius of the current sphere. The bin refers to discrete radii.

### V. Clustering

The measures of the various features are used to cluster cells. The set of features that best separate clusters from other clusters can be determined. The best features for separation can be determined by which feature (dimension) has the greatest distance between the clusters. Different sets of features can be tested, e.g., individually or in groups. The identification of the best features can be determined in a training of a clustering model, which can be used for new biological samples. The cluster model can be supervised, unsupervised, or semi-supervised.

Clustering may be performed for each new experiment. An experiment may include testing the effect of a treatment, the duration of a treatment, or the effect of a genetic perturbation. In some embodiments, data from one experiment may be combined with data from another experiment. But to combine data from multiple experiments, certain corrections may be performed. A batch correction technique may be applied to remove technical variation not of interest. For example, batch effects may be caused by variations in laser intensity over time, differences in antibody penetration, non-specific background variation, or parameters not shared between experiments (e.g., if experiments used different counterstains). After data from multiple experiments is combined, the clustering analysis may be performed again across all the microglia.

As an example for the input of any clustering, the feature bank for all detected microglia may be assembled into a large matrix consisting of rows of cells and columns of features. In another example, dimensional reduction can be applied to the features, thereby reducing the number of dimensions that are used for clustering. An example of such dimensional reduction is principal component analysis (PCA).

Features may be normalized before dimensional reduction. For example, features may be standardized using a quantile transform. The signal may be ordered by rank, then binned into a cumulative distribution (e.g., 1,000 bins). Those bins may then be scaled to match the cumulative distribution for the normal distribution. (e.g., scikit-learn.org/stable/modules/generated/sklearn.preprocessing. QuantileTransformer.html).

Dimensional reduction may also include removing features. Redundant features, including features that are highly correlated may be removed. For example, some highly correlated features may include volume and number of voxels and number of branches and number of branch points. The remaining features may be projected onto a low dimensional space using Principal Component Analysis (PCA), and/or clustered using algorithms such as K-means, hierarchical clustering, and HDBSCAN.

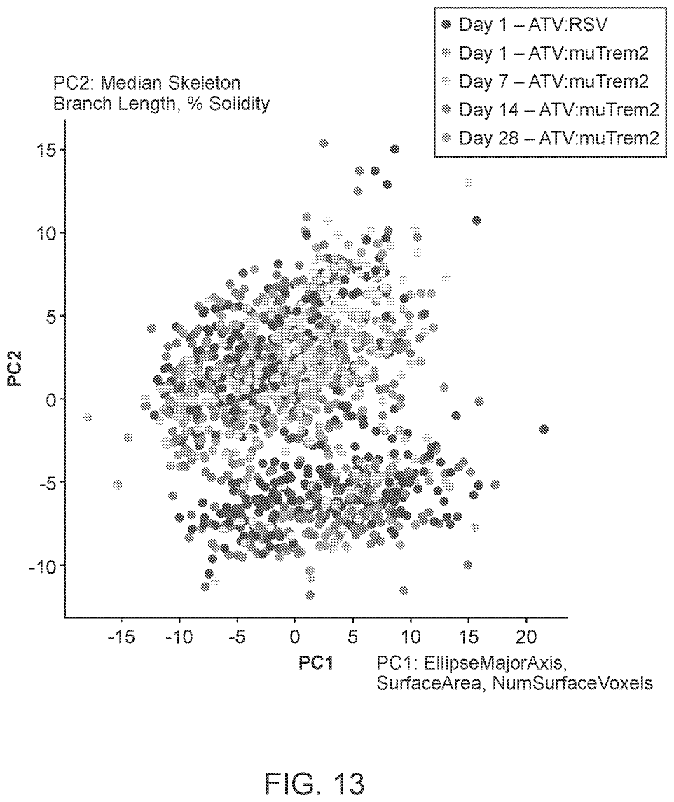

FIG. 13 shows a graph of principal components after removing features that are highly correlated with other features and after reducing dimensionality with PCA. The x-axis shows a principal component involving a major ellipse axis, a surface area, and number of surface voxels. The principal components are linear combinations of the feature values. The y-axis is a principal component involving median skeleton branch length and percent solidity. The different colors of the data points correspond to different tissue samples with different treatments or duration of treatment. The red dots show day 1 of ATV: RSV (antibody transport vehicle of RSV) treatment (the control treatment). The other dots show different days of ATV: muTREM2. The dots represent cells pooled across multiple animals that all received the same treatment. The reduced dimensionality data may then visualized using the Uniform Manifold Approximation and Projection (UMAP) to map experimental parameters onto clusters of distinct microglial morphologies.

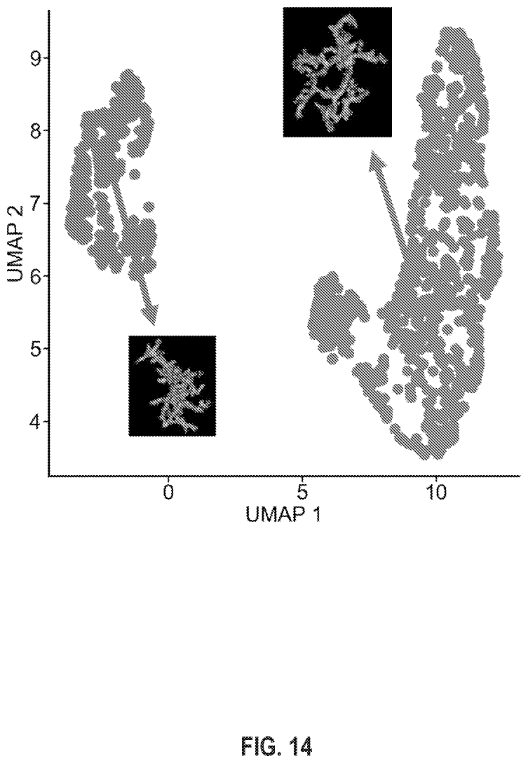

FIG. 14 shows clusters of cells in a projection on UMAP. The x-axis shows UMAP 1 parameter, and the y-axis shows UMAP 2 parameter. Projecting onto UMAP space indicates two distinct clusters: the left (red) cluster and the right (blue) cluster.

In some embodiments, the features defining clusters for the previous experiments may be applied to new experiments, particularly as a library of analyzed microglia becomes more and more developed. Features that are frequently used in previous clustering may be used to cluster a new data set. For example, clustering may use features that have been used in over 50%, 60%, 70%, 80%, or 90% of experiments that had image data previously clustered.

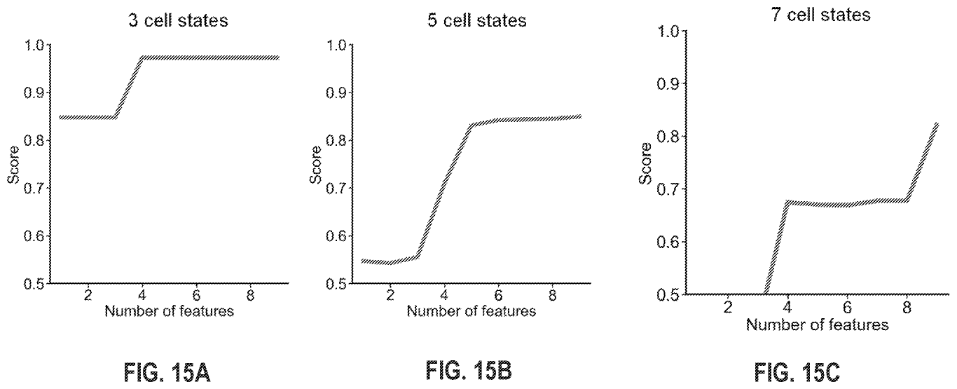

FIGS. 15A, 15B, and 15C show a comparison of using different number of features to cluster cells. FIGS. 15A, 15B, and 15C show the number of PCA features used for clustering on the x-axis. The figures show a score representing the accuracy of the clustering matching the cell states. FIG. 15A is a graph for three cell states. FIG. 15B is a graph for five cell states. FIG. 15C is a graph for seven cell states. The user specifies the number of cell states. The same feature bank was used, but clustering was attempted with different numbers of PCA features. The figures show that the score increases with more PCA features. For all numbers of cell states, using three or fewer features for clustering results in a lower score than using a higher number of features. With more cell states, a greater number of features may be used to generate a higher score. For example, while FIGS. 15A and 15B show a leveling off of score after four or five features, FIG. 15C shows that the score has not leveled off after nine features. Hence, having many features (e.g., as in generated in the feature bank) may be important in clustering for a high number of cell states present.

### VI. Cluster Classification

Each cluster may be manually or automatically classified as having a certain state based on the set of features characterizing the cluster. The values (e.g., statistical values) of the set of features of a cluster may be compared with reference values of reference cells having known states. For instance, homeostatic cells have larger branching indices of various kinds, are larger overall, and are less polarized, while responsive cells are smaller, have fewer or no detectible processes, and have a high degree of convexity/solidity. Values for a cluster may be compared to values for these reference cells to determine if the cluster is likely to be a homeostatic cell or a responsive cell. A cluster may be determined to match the state of a reference cell if a representative value of a representative cell is within a certain threshold of a reference value of a reference cell. The threshold may be a difference or a ratio. Individual representative microglia from a cluster (i.e., near the center of the cluster or being the centroid of the cluster) may be inspected to confirm labeling a cluster as a particular state. Cells of that cluster are then considered to be of that particular state even though not every single cell of the cluster was individually classified.

In FIG. 14, cells from the left cluster are analyzed and compared to reference cells. As a result of the comparison, the left cluster is determined to be responsive microglial cells. Cells from the right cluster are similarly analyzed and compared to reference cells. The right cluster is determined to be homeostatic microglial cells by a neurobiologist skilled in analyzing microglial cells. The person may examine one cell from a cluster and based on similarity to a reference cell (e.g., from a separate sample or based on previous experiments), classify the cluster as having the same state as the reference cell. The person may confirm the state of the cluster by examining 1, 2 to 5, 5 to 10, or more cells from the cluster and comparing the cells to the reference cell.

In some embodiments, two or more clusters may be classified as having the same state. In this situation, the two clusters may represent subtypes for the microglia may be identified. In some embodiments, a subtype may be determined to be a new state for the microglia if the subtype is found to be present or in a significant amount when treatments are found to be effective or when diagnosing a disorder/disease.

### A. Visualization for Classification

The cells of a cluster may not be located physically close to other cells of the cluster. By having a cluster of cells, a person does not need to select each cell and label each cell from various locations in an image or across different images.

Visualization of cells may be improved for a person classifying cells. A cluster of cells may be displayed such that the image of each cell may be recalled for review. For example, in FIG. 14, each dot may be clicked upon to bring up the image of the cell. In some embodiments, the image can highlight the cells of the same cluster so that the locations of the cells are readily apparent. A computer system may select a cell being the centroid or near the centroid of the cluster as a representative cell. This cell may be used by a person to classify the cluster. The representative cell may be a cell that has values of features closest to the mean, median, or mode values of all cells in the cluster.

In some embodiments, a computer system may display one or more reference cells. The image of a reference cell may be displayed to allow for easy or side-by-side comparison with an image of the representative cell or cells. In some embodiments, representative cells of multiple states may be displayed to facilitate comparison. The representative cells of multiple states displayed may be the most common states of cells or states that the computer system identifies as having values closest to cells in the cluster.

In some embodiments, a computer system may display reference clusters associated with reference cells. The clusters of the sample cells may be superimposed over the reference clusters. Clusters overlapping or near the reference clusters may be determined to be the same state as the reference cells.

### B. Classification Using Reference Features

In some embodiments, classification of the cluster may not require visualization of representative cells or reference cells. The comparison of the cells in the cluster with reference cells may involve a comparison of the values of features with a reference cell. The comparison may be performed by a human or by a computer system. Classification using reference features may be more efficient than other classification techniques.

A reference cell may be a cell having a known state from another subject (e.g., healthy, diseased). The values of the set of features distinguishing the cluster may be known for the reference cell, and these values may be the reference values. In some embodiments, more than one reference cell having the same known state may be used. The reference values may be a statistical value of the values for the multiple cells. In some embodiments, the reference value for a reference cell may be a total sum of values of the features or a weighted sum of the values of the features. The reference value used for comparison may be of a parameter determined from feature values (e.g., a principal component) instead of or in addition to a reference value for a feature.

The reference cell may have been previously classified by a person or a computer as having a certain state. A database may store the values of features of cells previously classified as a given state. Some or all of the cells previously classified may have been classified with methods described herein. The reference values of the set of features may be a statistical value of the values for the cells in the database classified as having the given state.

In some embodiments, a cluster classification may be determined to have certain ranges of values for a certain set of features. The determination of these ranges may be based on clusters previously identified and stored in a database. The values of features of a representative cell may be compared to the ranges, and if enough (e.g., over 50%, 60%, 70%, 80%, 90%, or equal to 100%) of the values are within the ranges, the representative cell may be classified as being the same state as cells in the cluster classification with the ranges.

### VII. Classification of Biological Sample

The behavior of a cluster of cells in response to a treatment or a genetic perturbation may be analyzed to determine the effect of the treatment or genetic perturbation, thereby classifying the biological sample and/or subject from which the biological sample is obtained. For example, shifts in the population distribution among different clusters may result from a treatment or genetic perturbation. An appearance of a new cluster (state) or the loss of a cluster (state) may indicate a positive or negative response to treatment. The shifts may signal whether a treatment or genetic perturbation is effective or ineffective.

For an experiment determining the effectiveness of different treatments, each treatment has clusters of cells determined, and the clusters of cells are classified. Certain cluster classifications may be present across different treatments. For example, different treatments may each have a homeostatic cluster and a responsive cluster.

Comparisons may be made relative to a cluster determined to have a homeostatic state. The majority of microglia may be expected to be homeostatic. A ratio of the number of cells in another state to the number of cells in a homeostatic state may be used to classify the biological sample. The ratio may be compared to one or more cutoff values (e.g., 1%, 2%, 5%, 10%, 20%, 30%, 40%, 50%, 60%, 70%, 80%, 90%, or 95%) to classify the biological sample. For example, if the ratio is high for a responsive cluster, then the biological sample may be classified as representing an effective treatment. The cutoff values may be determined using control biological samples that are from known healthy subjects, subjects known to have a disease, and/or subjects known to have an effective treatment.

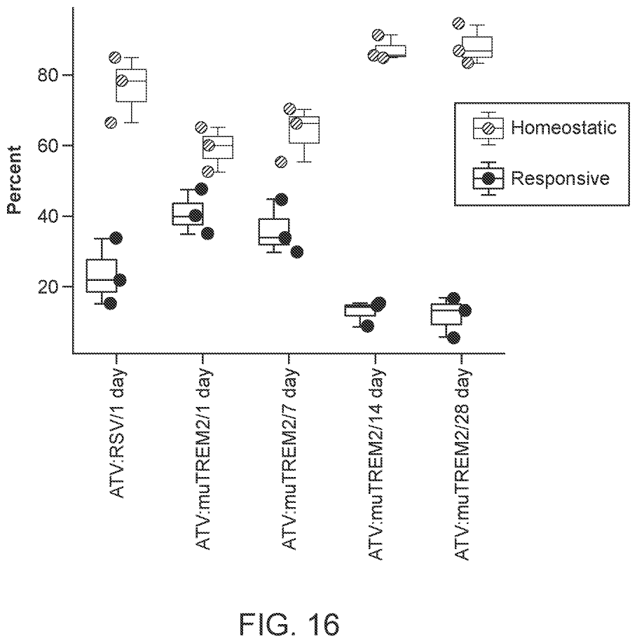

FIG. 16 shows the breakdown of homeostatic and responsive cells for different treatments. The x-axis shows the different treatments. The first two columns are 1-day after treatments. After the first two columns, the number of days after treatment increases. The y-axis shows the percentage of microglial cells that are in each state. The top data (shown in blue) represent homeostatic microglia. The bottom data (shown in red) represent responsive microglia. As shown in FIG. 16, the percentage of responsive microglia increases after ATV: muTREM2 treatment and then decreases as more time passes. The data suggests that the treatment is successful in elevating responsive microglia for about one week. Similar analysis may be applied to study genetic perturbations in addition to treatments. In some embodiments, the presence of certain microglial states or the amount of cells in certain microglial states may indicate a disorder.

### VIII. Example Methods

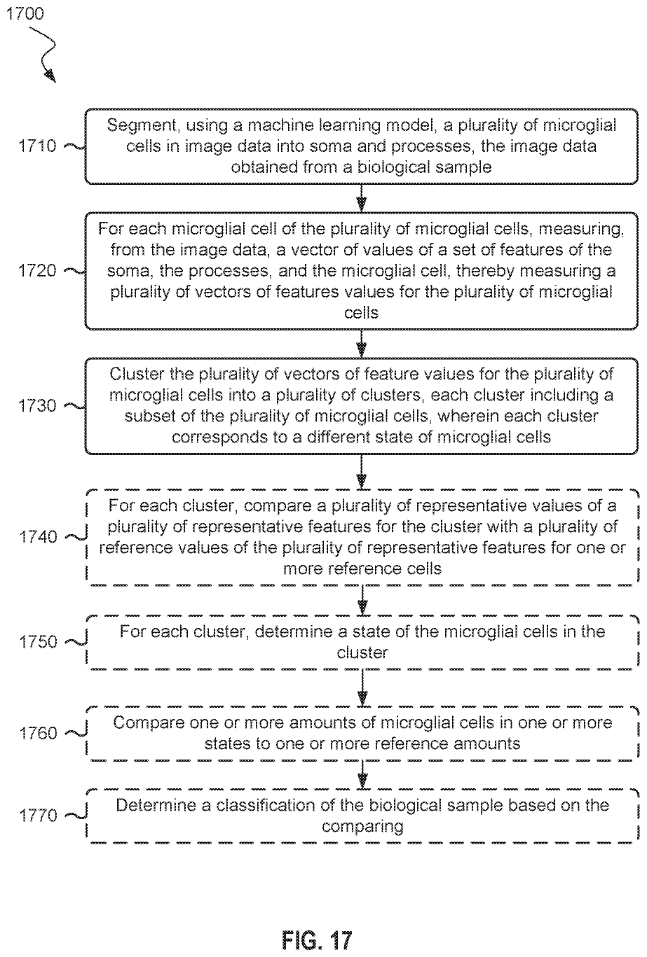

FIG. 17 is a flowchart of an example process 1700 of analyzing a biological sample of nerve cells including microglial cells. In some implementations, one or more process blocks of FIG. 17 may be performed by a system (e.g., system 1800). In some implementations, one or more process blocks of FIG. 17 may be performed by another device or a group of devices separate from or including the system. Additionally, or alternatively, one or more process blocks of FIG. 17 may be performed by one or more components of computer system 10, such as processor 73, memory 72, storage device 79, I/O port 77, I/O controller 71, external interface 81, and/or data collection device 85.

The biological sample may be a tissue sample. The tissue sample may be a brain tissue sample, a spinal cord tissue sample, or any tissue sample described herein. In some embodiments, the tissue sample may be obtained from a subject post-mortem as described herein. The image data may be received by a computer system. In some embodiments, the image data may be obtained by performing immunohistochemistry microscopy of the tissue sample or through any technique described herein. The microscopy image data may be obtained without using two stains to differentiate between the soma and the processes. For example, the image data may be obtained using one stain for the processes without another stain for the soma or one stain for the soma without another stain for the processes. The image data may be one or more three-dimensional images or one or more two-dimensional images. For example, the image data may include from 10 to 50, 50 to 100, 100 to 200, 200 to 300, 300 to 400, 400 to 500, or more than 500 images. Each image may include 10 to 20 microglial cells. In some embodiments, images may include the entire brain or over 50%, 60%, 70%, 80%, or 90% of the brain. Images may include a total of 10,000 to 100,000 microglial cells.

In some embodiments, the biological sample may be a cell culture sample, including any cell culture described herein. The cell culture may include pluripotent stem cell-derived microglia or iMG (induced microglia-like cells). The cell culture may be disposed in a high throughput plate format.

The image data may include a value representing an intensity for each pixel or voxel. For a grayscale image, the intensity may be how black or how white the voxel is. For a color image, the intensity may be the RGB (red, green, blue) values or other color model values. The intensity may be represented on any arbitrary scale. For example, the intensity may be a value between 0 and 1, 0 and 10, 0 and 100, 0 and 255, 0 and 4095, or 0 and 65,535.

At block 1710, a plurality of microglial cells in image data may be segmented into soma and processes using a machine learning model. The image data may also be segmented into microglial cells and other cells or any segment described herein. The image data may be obtained from the biological sample. The machine learning model may be a convolutional neural network (CNN). Supervised learning models may be used. Supervised learning models may include different approaches and algorithms including artificial neural network, backpropagation, boosting (meta-algorithm), Bayesian statistics, decision tree learning, kernel estimators, naive Bayes classifier, conditional random field, Nearest Neighbor Algorithm, support vector machines, random forests and other ensembles of classifiers. The model may use linear regression, logistic regression, Bayes classifier, linear discriminant analysis (LDA), k-means clustering, density-based spatial clustering of applications with noise (DBSCAN), random forest algorithm, support vector machine (SVM), or any model described herein.

In some embodiments, the machine learning model may be trained by receiving a plurality of training images. Each training image of the plurality of training images may include a microglial cell. Each training image may include a first region labeled as a soma and one or more second regions labeled as processes. Training the machine learning model may include optimizing parameters of the machine learning model based on outputs of the machine learning model matching or not matching the first region and the one or more second regions when the plurality of training images is input into the machine learning model. An output of the model may specify a region corresponding to a soma or a process.

At block 1720, for each microglial cell of the plurality of microglial cells, a vector of values of a set of features of the soma, the processes, and the microglial cell may be measured from the image data. As a result of measuring each microglial cell, a plurality of vectors of features values for the plurality of microglial cells may be measured. In some embodiments, the set of features may be predetermined. For example, the set of features may be determined through a clustering analysis similar to described herein but for other image data and/or other microglial cells. The number of features in the set of features may be from 50 to 100, 100 to 200, 200 to 300, 300 to 400, 400 to 500, or over 500.

As examples, the set of features may include proximity to a plaque, intensity of a marker of microglia activation; percentage of overlap with a marker of cell division; volume (e.g., of hull of object); surface area (e.g., of hull of object); a moment of inertia; unitless combinations of volume, surface area, and/or moment of inertia; skeletal parameters (such as number of branches, length of branches, ramification index of the max number of branches divided by the total number of branches, branching index, number of voxels in the skeleton); fractal parameters (such as Sholl coefficients, the box-counting dimension, number of bins used to calculate Sholl statistics); an intensity and variation of fluorescent counterstains within, at, or near each cell surface; a number of other segmented objects contained within the microglial surface; a number of segmented objects at a radius, a number of segmented objects; a Boolean combination of their volumes; the distances between microglia, and to other segmented objects; or network parameters calculated from the induced graph of microglial nearest neighbors at different neighborhood sizes. Different intensity parameters may be used including the intensity of a stain within an object, core, and/or shell. A statistical value (e.g., mean, median, mode, standard deviation, percentile) of the intensity may be used. The plurality of features may include any features described herein. One feature may be used or any combination of features may be used.

At block 1730, the plurality of vectors of feature values for the plurality of microglial cells may be clustered into a plurality of clusters. Each cluster may include a subset of the plurality of microglial cells. Each cluster may correspond to a different state of microglial cells. Clustering may include using techniques such as principal component analysis (PCA), UMAP, K-means clustering, hierarchical clustering, HDBSCAN), non-negative matrix factorization (NMF), kernel PCA, graph-based kernel PCA, linear discriminant analysis (LDA), generalized discriminant analysis (GDA), autoencoders, t-distributed stochastic neighbor embedding (t-SNE), or independent component analysis (ICA). The number of clusters may be from 2 to 5, 5 to 10, 10 to 15, 15 to 20, or over 20. The number of clusters may match the number of different states of microglial cells.

At block 1740, for each cluster of the plurality of clusters, a plurality of representative values of a plurality of representative features for the cluster is compared with a plurality of reference values of the plurality of representative features for one or more reference cells. The representative value may be a value associated with a cell that is a centroid of a cluster, ranges around an average value, or any representative value described herein. Each reference cell of the one or more reference cells may have a same known state. The known state of the reference cells may be responsive, homeostatic, dysfunctional, activated, not activated, quiescent, amoeboid, undergoing cell division, rod-like, ramified, hypertrophic, dystrophic, an Alzheimer-specific state (e.g., near a plaque), or any state described herein. In some embodiments, the state for a cluster may not correspond to a known state of reference cells or a known morphological categorization of reference cells.

In some embodiments, comparing the plurality of representative values and the plurality of reference values may include determining each representative value of the plurality of representative values is within a respective threshold of the corresponding reference value of the plurality of reference values. The threshold may be a certain percentage or raw number of the corresponding reference value. For example, the threshold may be within plus or minus 10%, 20%, 30%, 40%, 50%, 60%, 70%, 80%, 90%, or 100% of the corresponding reference value. In some embodiments, the threshold may be within a certain number of standard deviations of the corresponding reference value, which may be a mean or median. For example, the threshold may be one, two, or three standard deviations of the corresponding reference value.

The plurality of reference values may include a plurality of statistical values. The plurality of representative values may include a plurality of statistical values. The statistical value may be an average (mean), median, mode, or percentile. The representative values may include a combination of different statistical values.

In some embodiments, the plurality of representative features is the same as the set of features. In other embodiments, the plurality of representative features is an incomplete subset of the set of features.

At block 1750, for each cluster, a state of the microglial cells in the cluster may be determined based on the comparing of the plurality of representative values. Determining the state of the microglial cells in the cluster may include determining the state of the microglial cells in the cluster is the same as the known state when the comparison shows the representative value is within the threshold. Each microglial cell in the cluster may be determined to have the same state as the other cells in the cluster. In some embodiments, not all microglia cells in the cluster may have the same state though the cells in the cluster are assigned the state. For example, the cluster may have over 70%, 75%, 80%, 85%, 90%, 95%, or 99% of the cells be the same state.

At block 1760, one or more amounts of microglial cells in one or more states may be compared to one or more reference amounts. The one or more amounts may be proportions of the microglial cells having the one or more states. For example, one amount may be the proportion of the microglial cell having the one state out of all microglial cells. In some embodiments, one amount may be a ratio of one state of microglial cell to another state. In some embodiments, one amount may be the number of microglial cells in a state.

At block 1770, a classification of the biological sample may be determined based on the comparing of the one or more amounts to the one or more reference amounts. The comparing may be determining whether the one or amounts are greater or less than the one or more reference amounts. The comparing may use a threshold or cutoff value to differentiate between an amount significantly different from the reference amount. The reference amount may be an amount for an effective treatment or an ineffective treatment. The reference amount may be an amount for a healthy subject or a subject having an CNS disorder.

In some embodiments, blocks 1740 to 1770 may be performed by a pathologist, medical practitioner, or expert having knowledge of microglial cells. This person may be able to identify the state of the cells corresponding to the cluster by examining one or more cells from a cluster and determining that the cells are similar to or different from reference cells with known states.

The classification may be used to measure the effectiveness of a treatment. The biological sample may be a first biological sample. The first biological sample may be obtained from a subject undergoing a treatment for a disease. The one or more reference amounts may be from a second biological sample obtained from a control subject not undergoing the treatment for the disease. The classification of the biological sample may be a level of effectiveness of the treatment.

In some embodiments, the one or more reference amounts may be from a second biological sample obtained from the same subject. The second biological sample may be from the same subject before the treatment, at a different time period of the treatment, or with a different treatment. In some embodiments, methods may include administering the treatment to the subject. In embodiments, methods may include administering the treatment ex vivo to cells obtained from a subject.

The classification may be that the treatment is effective. The treatment may be classified as effective because the one or more amounts of one or more states are greater than the one or more reference amounts. For example, the state may be responsive microglia, and the one or more reference amounts correspond to a control subject not having an effective treatment. The process may further include continuing treatment of the subject. In some embodiments, a computer system may display an output to continue the dosage of the treatment to the subject.

In some embodiments, the classification may be that the treatment is not effective. The treatment may be classified as ineffective because the one or more amounts of one or more states are less than or equal to the one or more reference amounts. For example, the state may be responsive microglia, and the one or more reference amounts correspond to a control subject not having an effective treatment. In some embodiments, a computer system may display an output to discontinue the treatment, increase the dosage of the treatment, or change the treatment. The classification may be used to understand response to the dose of treatment. The process may include discontinuing the treatment, increasing the dosage of the treatment, administering the increased dosage to the subject, or changing the treatment.

The biological sample may be a first biological sample. The first biological sample may be obtained from a subject having a genetic perturbation. The genetic perturbation may be a genetic mutation, e.g., as a result of deleting (knock-out) a particular gene. The reference amounts may be from a second biological sample obtained from a control subject without the genetic perturbation. The classification of the biological sample may be a level of an effect of the genetic perturbation.

In some embodiments, the classification of the biological sample may be that the biological sample indicates a disorder, a disease, or an injury (e.g., brain injury, concussion) in the subject. For example, a high level of the one or more amounts relative to the one or more reference amounts may indicate a disorder, a disease, or an injury. In other embodiments, a low level of the one or more amounts relative to the one or more reference amounts may indicate a disorder, a disease, or an injury. Disorders may include CNS disorders such as seizures, epilepsy, cerebrovascular diseases, migraines, Alzheimer's Disease, Parkinson's Disease, dystonia, and restless leg syndrome.

Process 1700 may include additional implementations, such as any single implementation or any combination of implementations described herein and/or in connection with one or more other processes described elsewhere herein.

Although FIG. 17 shows example blocks of process 1700, in some implementations, process 1700 may include additional blocks, fewer blocks, different blocks, or differently arranged blocks than those depicted in FIG. 17. Additionally, or alternatively, two or more of the blocks of process 1700 may be performed in parallel.

### IX. Example Systems

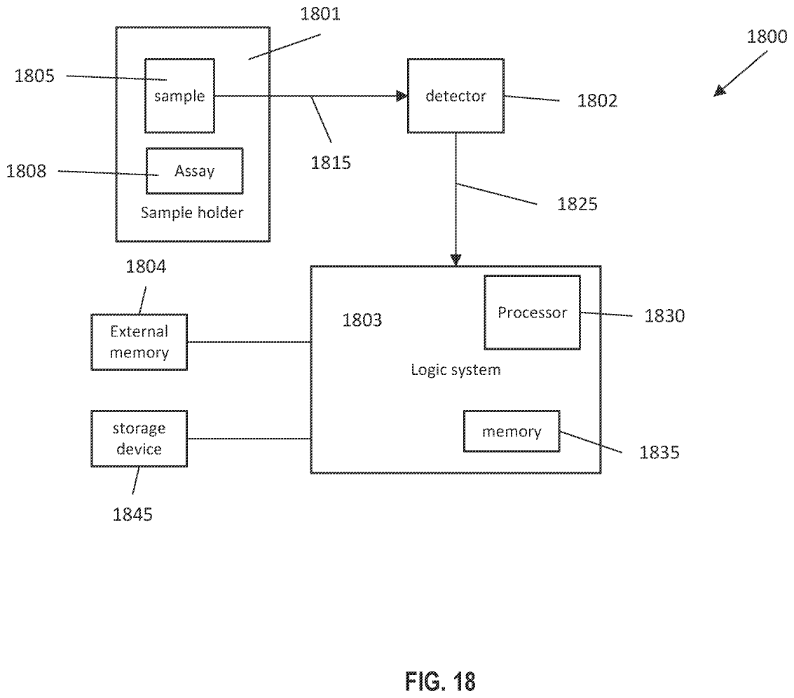

FIG. 18 illustrates a measurement system 1800 according to an embodiment of the present invention. The system as shown includes a sample 1805, such as DNA molecules within a sample holder 1801, where sample 1805 can be contacted with an assay 1808 to provide a signal of a physical characteristic 1815. An example of a sample holder can be a microscope stand. Physical characteristic 1815 (e.g., a fluorescence intensity, a voltage, or a current), from the sample is detected by detector 1802. Detector 1802 can take a measurement at intervals (e.g., periodic intervals) to obtain data points that make up a data signal. In one embodiment, an analog-to-digital converter converts an analog signal from the detector into digital form at a plurality of times. Sample holder 1801 and detector 1802 can form an assay device, e.g., a fluorescence microscope according to embodiments described herein. A data signal 1825 is sent from detector 1802 to logic system 1803. Data signal 1825 may be stored in a local memory 1835, an external memory 1804, or a storage device 1845.

Logic system 1803 may be, or may include, a computer system, ASIC, microprocessor, etc. It may also include or be coupled with a display (e.g., monitor, LED display, etc.) and a user input device (e.g., mouse, keyboard, buttons, etc.). Logic system 1803 and the other components may be part of a stand-alone or network connected computer system, or they may be directly attached to or incorporated in a device (e.g., a sequencing device) that includes detector 1802 and/or sample holder 1801. Logic system 1803 may also include software that executes in a processor 1830. Logic system 1803 may include a computer readable medium storing instructions for controlling system 1800 to perform any of the methods described herein. For example, logic system 1803 can provide commands to a system that includes sample holder 1801 such that illumination or other physical operations are performed. Such physical operations can be performed in a particular order, e.g., with reagents being added and removed in a particular order. Such physical operations may be performed by a robotics system, e.g., including a robotic arm, as may be used to obtain a sample and perform an assay.

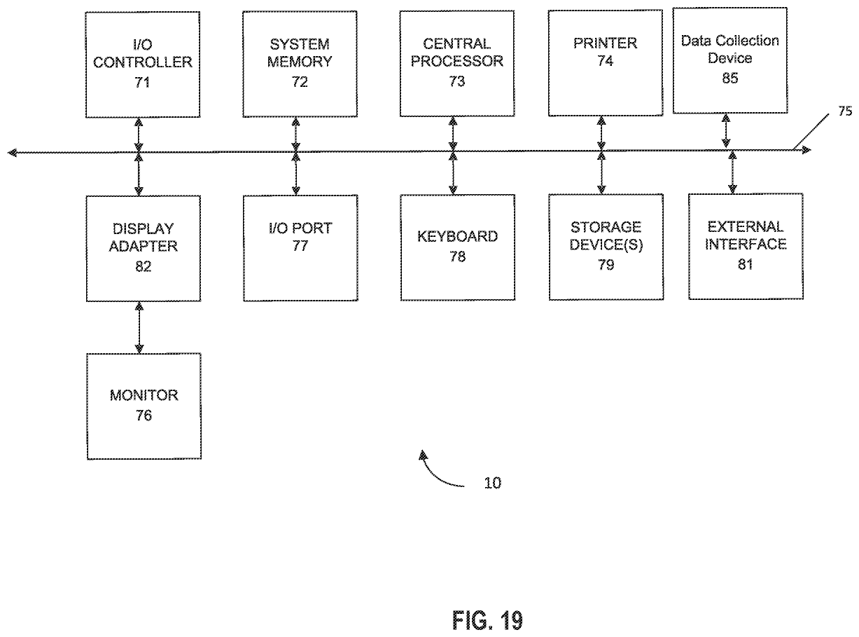

Any of the computer systems mentioned herein may utilize any suitable number of subsystems. Examples of such subsystems are shown in FIG. 19 in computer system 10. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones, other mobile devices, and cloud-based systems.

The subsystems shown in FIG. 19 are interconnected via a system bus 75. Additional subsystems such as a printer 74, keyboard 78, storage device(s) 79, monitor 76 (e.g., a display screen, such as an LED), which is coupled to display adapter 82, and others are shown. Peripherals and input/output (I/O) devices, which couple to I/O controller 71, can be connected to the computer system by any number of means known in the art such as input/output (I/O) port 77 (e.g., USB, FireWire®). For example, I/O port 77 or external interface 81 (e.g., Ethernet, Wi-Fi, etc.) can be used to connect computer system 10 to a wide area network such as the Internet, a mouse input device, or a scanner. The interconnection via system bus 75 allows the central processor 73 to communicate with each subsystem and to control the execution of a plurality of instructions from system memory 72 or the storage device(s) 79 (e.g., a fixed disk, such as a hard drive, or optical disk), as well as the exchange of information between subsystems. The system memory 72 and/or the storage device(s) 79 may embody a computer readable medium. Another subsystem is a data collection device 85, such as a camera, microphone, accelerometer, and the like. Any of the data mentioned herein can be output from one component to another component and can be output to the user.

A computer system can include a plurality of the same components or subsystems, e.g., connected together by external interface 81, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components.

Aspects of embodiments can be implemented in the form of control logic using hardware circuitry (e.g., an application specific integrated circuit or field programmable gate array) and/or using computer software with a generally programmable processor in a modular or integrated manner. As used herein, a processor can include a single-core processor, multi-core processor on a same integrated chip, or multiple processing units on a single circuit board or networked, as well as dedicated hardware. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium such as a compact disk (CD) or DVD (digital versatile disk) or Blu-ray disk, flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order. Additionally, portions of these steps may be used with portions of other steps from other methods. Also, all or portions of a step may be optional. Additionally, any of the steps of any of the methods can be performed with modules, units, circuits, or other means of a system for performing these steps.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of example embodiments of the present disclosure has been presented for the purposes of illustration and description. It is not intended to be exhaustive or to limit the disclosure to the precise form described, and many modifications and variations are possible in light of the teaching above.

A recitation of “a”, “an”, or “the” is intended to mean “one or more” unless specifically indicated to the contrary. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

All patents, patent applications, publications, and descriptions mentioned herein are incorporated by reference in their entirety for all purposes. None is admitted to be prior art.

1. A method of analyzing a biological sample of nerve cells including microglial cells, the method comprising:
segmenting, using a machine learning model, a plurality of microglial cells in image data into soma and processes, the image data obtained from the biological sample;
for each microglial cell of the plurality of microglial cells:
measuring, from the image data, a vector of values of a set of features of the soma, the processes, and the cell body, thereby measuring a plurality of vectors of feature values for the plurality of microglial cells; and
clustering the plurality of vectors of feature values for the plurality of microglial cells into a plurality of clusters, each cluster including a subset of the plurality of microglial cells, wherein each cluster corresponds to a different state of microglial cells.

2. The method of claim 1, the method comprising:
for each cluster of the plurality of clusters:
comparing a plurality of representative values of a plurality of representative features for the cluster with a plurality of reference values of the plurality of representative features for one or more reference cells, each having a same known state, and
determining a state of the microglial cells in the cluster based on the comparing of the plurality of representative values with the plurality of reference values;
comparing one or more amounts of microglial cells in one or more states to one or more reference amounts; and
determining a classification of the biological sample based on the comparing.

3. The method of claim 2, wherein:
the biological sample is a first biological sample,
the first biological sample is obtained from a subject undergoing a treatment for a disease,
the one or more reference amounts are from a second biological sample obtained from a control subject not undergoing the treatment for the disease, and
the classification of the biological sample is a level of effectiveness of the treatment.

4. The method of claim 2, wherein the one or more amounts are proportions of the microglial cells having the one or more states.

5. The method of claim 3, wherein the classification is that the treatment is effective, the method further comprising continuing treatment of the subject.

6. The method of claim 2, wherein:
the biological sample is a first biological sample,
the first biological sample is obtained from a subject having a genetic perturbation,
the reference amounts are from a second biological sample obtained from a control subject without the genetic perturbation, and
the classification of the biological sample is a level of an effect of the genetic perturbation.

7. The method of claim 1, wherein the set of features comprises proximity to a plaque; intensity of a marker of microglia activation; percentage of overlap with a marker of cell division; volume; surface area; a moment of inertia; unitless combinations of volume, surface area, and/or moment of inertia; skeletal parameters; fractal parameters; an intensity and variation of fluorescent counterstains within, at, or near each cell surface, a number of other segmented objects contained within the microglial surface; a Boolean combination of their volumes, the distances between microglia, and to other segmented objects; or network parameters calculated from the induced graph of microglial nearest neighbors at different neighborhood sizes.

8. The method of claim 1, wherein the set of features is predetermined.

9. The method of claim 2, wherein the known state of the reference cells is responsive, homeostatic, dysfunctional, activated, not activated, quiescent, amoeboid, undergoing cell division, rod-like, ramified, hypertrophic, dystrophic, or an Alzheimer-specific state.

10. The method of claim 2, wherein the plurality of representative values comprises a plurality of statistical values.

11. The method of claim 2, wherein the plurality of reference values comprises a plurality of statistical values

12. The method of claim 1, further comprising receiving, by a computer system, the image data.

13. The method of claim 12, further comprising obtaining the image data by performing immunofluorescence microscopy of the biological sample.

14. The method of claim 1, wherein the image data is immunofluorescence microscopy image data, and the immunofluorescence microscopy image data is obtained without using two stains to differentiate between the soma and the processes.

15. The method of claim 1, further comprising training the machine learning model by:
receiving a plurality of training images, each training image of the plurality of training images including a microglial cell and including a first region labeled as a soma and one or more second regions labeled as processes, and
optimizing parameters of the machine learning model based on outputs of the machine learning model matching or not matching the first region and the one or more second regions when the plurality of training images is input into the machine learning model, wherein an output of the model specifies a region corresponding to a soma or a process.

16. The method of claim 1, wherein the machine learning model comprises a convolutional neural network.

17. The method of claim 1, wherein clustering comprises using principal component analysis, UMAP, K-means clustering, hierarchical clustering, or HDBSCAN.

18. The method of claim 1, wherein the image data is from one or more three-dimensional images.

19. The method of claim 2, wherein comparing the plurality of representative values and the plurality of reference values comprises:
determining each representative value of the plurality of representative values is within a respective threshold of the corresponding reference value of the plurality of reference values, and
wherein determining a state of the microglial cells in the cluster comprises determining the state of the microglial cells in the cluster is the same as the known state.

20. The method of claim 2, wherein the plurality of representative features is the same as the set of features.

21-23. (canceled)
